(19) United States
(12) Patent Application Publication
(10) Pub. No.: US 2025/0349040 A1
(43) Pub. Date: Nov. 13, 2025

(54) PERSONALIZED IMAGE GENERATION USING COMBINED IMAGE FEATURES

(71) Applicant: Snap Inc., Santa Monica, CA (US)

(72) Inventors: Kfir Aberman, Redwood City, CA (US); Andrey Alejandrovich Gomez Zharkov, Los Angeles, CA (US); Elena Koritskaya, London (GB); Daniil Ostashev, London (GB)

(21) Appl. No.: 18/660,000

(22) Filed: May 9, 2024

(51) Int. Cl. G06T 11/00; G06T 9/00; G06V 40/16

(52) U.S. Cl. CPC G06T 11/00; G06T 9/00; G06V 40/168; G06V 40/174

(57) ABSTRACT

Examples described herein relate to personalized image generation using combined image features. A plurality of input images is provided by a user of an interaction application. Each of the plurality of input images depicts at least part of a subject. Each input image is encoded to obtain an identity representation. The identity representations obtained from the plurality of input images are combined to obtain a combined identity representation associated with the subject. A personalized output image is generated via a generative machine learning model. The generative machine learning model processes the combined identity representation and at least one additional image generation control to generate the personalized output image. At a user device, the personalized output image is presented in a user interface of the interaction application.

### TECHNICAL FIELD

Subject matter disclosed herein relates to automated image generation. More specifically, but not exclusively, the subject matter relates to the generation of personalized images.

### BACKGROUND

The field of automated image generation, including artificial intelligence (AI) driven image generation, continues to grow. For example, machine learning models can be trained to process natural language descriptions (referred to herein as “text prompts”) and automatically generate corresponding visual outputs.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system, according to some examples, that has both client-side and server-side functionality.

FIG. 3 is a diagrammatic representation of a data structure as maintained in a database, according to some examples.

FIG. 4 is a diagrammatic representation of an image generation system, according to some examples.

FIG. 5 is a diagrammatic representation of an image generation process that utilizes multiple AI-implemented components, according to some examples.

FIG. 6 is a diagrammatic representation of a decoupled cross-attention mechanism of a diffusion model, according to some examples.

FIG. 7 is a flowchart illustrating operations of a method suitable for encoding a plurality of input images and generating a personalized output image, according to some examples.

FIG. 8 is a flowchart illustrating operations of a method suitable for automatically guiding a user of an interaction application to provide a plurality of input images used to generate a combined identity representation associated with a subject, according to some examples.

FIG. 9 is a flowchart illustrating a machine learning pipeline, according to some examples.

FIG. 10 diagrammatically illustrates training and use of a machine learning program, according to some examples.

FIG. 11 is a flowchart illustrating operations of a method suitable for integrating additional components into a pre-trained diffusion model and training the additional components to adjust parameters thereof for personalized image generation, according to some examples.

FIG. 12 is a diagrammatic representation of a message, according to some examples.

FIG. 13 illustrates a network environment in which a head-wearable apparatus can be implemented according to some examples.

FIG. 14 is a diagrammatic representation of a machine in the form of a computer system within which a set of instructions may be executed to cause the machine to perform any one or more of the methodologies discussed herein, according to some examples.

FIG. 15 is a block diagram showing a software architecture within which some examples may be implemented.

### DETAILED DESCRIPTION

Various types of automated image generation systems utilize generative AI technology, such as diffusion models or Generative Adversarial Networks (GANs), to generate images in response to user requests. Text prompts are typically used as an image generation control in automated image generation systems.

It can be challenging to generate suitable images based on text prompts alone. For example, an automated image generation system can leverage a diffusion model that was trained on a diverse range of images of humans. A user might be interested in obtaining a personalized image, such as an image showing an AI-generated person with facial features resembling those of the user. Even if the user describes their own facial features in detail in a text prompt, it is usually unlikely that the AI-generated person will have an exact or near-exact resemblance to the user.

Some automated image generation systems are configured to accept image-based inputs, which can be referred to as “image prompts.” For example, an automated image generation system can process an input image to generate a latent-space representation of features of the input image, and then feed the latent-space representation into a generative machine learning model (e.g., a diffusion model) to guide the generation of an output image.

These and other advancements in automated image generation systems can facilitate the image generation process by making it more controllable. Specifically, but not exclusively, these advancements allow for greater personalization of output images. For example, when leveraging image prompts, facial features of a person can be captured via a latent-space representation generated from an input image depicting the person, thereby enabling an automated image generation system to generate an output image that depicts an AI-generated person with similar facial features (thus resembling the real person in the input image). In this way, identity information can be injected into the image-generation process to allow a user to obtain an image of an AI-generated person that more closely resembles the user.

The image-based generation process can also incorporate a text prompt as an additional image generation control. In other words, in some cases, an automated image generation system is multimodal in the sense that it is configured to generate an output image based on both a text prompt and an input image. A user of the automated image generation system might, for example, upload an image of their face and provide a text prompt, “at the beach.” The automated image generation system then processes the inputs and generates an output image depicting an AI-generated person resembling the user (at least to some extent) and relaxing on a beach or standing in the ocean.

While automated image generation systems can provide personalized images that are interesting or entertaining, technical challenges persist in generating high-fidelity personalized images. Firstly, the process of generating latent-space representations from input images and subsequently feeding these into generative machine learning models can be computationally intensive and time-consuming, especially when dealing with high-resolution images or complex transformations. This not only increases the demand for high computational power but also leads to significant energy consumption, which can be costly and environmentally impactful.

Moreover, the need to fine-tune the system to handle both image and text prompts for generating personalized output images adds another layer of complexity. This often requires extensive training data and iterative adjustments to the model, which can be resource-intensive in terms of both time and computational power. Additionally, achieving high fidelity in the personalized images, where the output closely resembles the input while also incorporating requested scenarios (like the example of being “at the beach”), often requires multiple processing iterations. Each iteration consumes resources without guaranteeing satisfactory results on the first attempt, leading to potential inefficiencies where resources are expended but do not necessarily yield proportionate benefits.

Examples in the present disclosure address or alleviate one or more of these technical challenges by allowing for the injection of more accurate or consistent identity information into an image generation process in a more efficient manner. Furthermore, machine learning model training processes described herein allow for training in a many-to-one prediction fashion to enable the effective generation of such identity information during inference.

An example method includes accessing a plurality of input images provided by a user of an interaction application. Each of the plurality of input images depicts at least part of a subject (e.g., the face of the subject or the upper body of the subject). The subject may be the user or another person or entity. Each input image is encoded to obtain, from the input image, an identity representation. The identity representations are combined to obtain a combined identity representation associated with the subject.

The term “identity representation,” as used herein, includes a representation of characteristics or features of a person or other entity. In some examples, the identity representation is obtained by encoding an image using an image encoder. The identity representation can include a vector or set of vectors (e.g., one or more feature vectors, latent-space representations, or embeddings) that encode various attributes and/or features of the entity (such as facial features). The term “combined identity representation,” as used herein, includes a representation that is obtained by combining, merging, or aggregating multiple individual identity representations associated with the same person or entity. A combined identity representation can include a vector or set of vectors (e.g., one or more feature vectors, latent-space representations, or embeddings) that integrate multiple identity representations generated from respective input images to form a unified profile or feature set that captures features to characterize an identity of an entity.

In some examples, each of the plurality of input images depicts a face of the subject, and the combined identity representation comprises a representation of facial features of the subject. The method may include generating an instruction to provide, among the plurality of input images, depictions of the face of the subject from different angles and/or depictions of different facial expressions of the subject. As a result, the combined identity representation can be generated from diverse input images that depict the same person to create an accurate and/or more consistent representation of the person.

In some examples, the method includes generating a personalized output image via a generative machine learning model, such as a diffusion model, that processes the combined identity representation. In addition to the combined identity representation, in some examples, the generative machine learning model also processes at least one additional image generation control. The personalized output image is caused to be presented in a user interface of the interaction application.

As mentioned above, a text prompt is an example of an image generation control. More specifically, a text prompt representation, obtained by processing the text prompt via a text encoder, can be used as the additional image generation control. Alternatively, or additionally, one or more structural conditions can be used as image generation controls. Examples of structural conditions include structural maps, edge maps, depth maps, or pose maps that guide image generation from a structural or spatial perspective. A structural condition might, for example, be provided as an additional input to specify where to position one or more objects relative to each other in the personalized output image.

In some examples, the personalized output image is generated by automatically providing the combined identity representation and the additional image generation control to the generative machine learning model via a decoupled cross-attention mechanism. The decoupled cross-attention mechanism allows the generative machine learning model to process the combined identity representation and the additional image generation control separately. For example, the generative machine learning model includes separate cross-attention layers for the combined identity representation and the text prompt representation, respectively.

In some examples, during a training phase, an automated image generation system of the present disclosure is exposed to respective sets of multiple training images along with a target output. Each set of training images and its target output depict the same person. The image generation system is trained to extract or preserve essential identity-defining characteristics that are consistent across different images of the same person. For example, the image generation system learns to “ignore” features or variations that do not contribute to core identity features. Through multiple images that show a person from various angles or depict different expressions, the image generation may also better capture the person's features. The image generation system may generate personalized output images that faithfully represent a desired identity when presented with new, unseen images.

A merging component can be configured to combine different identity representations to obtain a combined identity representation. In some examples, the merging component is a machine-learning based component that is trained to generate, for a given set of identity representations encoded from respective training images of a person, a corresponding combined identity representation for the person.

Techniques described herein can be used to generate individual images or video content. In some examples, the personalized output image is one of a plurality of frames of a personalized video. For example, a personalized video is generated for the user, via the interaction application, based on the combined identity representation and an additional image generation control, such as a text prompt. The personalized video comprises multiple frames that depict a person resembling the subject, based on the combined identity representation.

Subject matter of the present disclosure improves the functioning of a computing system by allowing for higher-fidelity, personalized images to be generated in an automated manner, and reduces the amount of resources needed to accomplish the task. Image quality can be improved and/or stabilized, and identity information from image-based inputs can be better preserved using techniques described herein. Subject matter of the present disclosure also provides techniques that can improve the controllability of AI-implemented image generation.

Examples described herein address or alleviate one or more technical problems associated with the automated generation of images incorporating identity information, such as facial features of a person. Existing image generation systems may struggle with accurately capturing and representing the identity of a subject. For example, a user provides a single “selfie” input image that does not sufficiently capture nuances of the user's identity, or includes blemishes, obscured features, or temporary features. This can lead to generated images that do not truly reflect the user's identity, especially in varying contexts or expressions. Subject matter of the present disclosure addresses this technical issue by creating a merged or combined identity representation associated with a subject, leading to more accurate and personalized output images.

For example, in a particular input image depicting a subject, the subject might have a blemish on their face, a shadow obscuring part of their face, or be wearing a cap or sunglasses. Instead of being trained to reconstruct the same features that appear in an input image, potentially leading to unwanted features being included in the output image, the automated image generation system is trained to construct “something new,” which is an image capturing a set of merged or aggregated features taken from multiple input images. In other words, in some examples, the system is configured to synthesize an image with a combined identity representation instead of attempting to synthesize an image from one specific identity representation originating from a given input image. By utilizing multiple different images of the subject, the image generation system can generate a combined identity representation that better captures identifying characteristics of the subject. For example, the combined identity representation can reflect characteristics that are evident across most or all input images, thereby essentially filtering out unwanted or temporary features, such as those mentioned above.

Examples described herein also enhance flexibility of an image generation system by incorporating one or multiple image generation controls (e.g., a text prompt and a pose map). By processing the combined identity representation with these additional controls through a generative machine learning model, the image generation system produces personalized output images (also referred to as artificial or synthesized images) that align more closely with the user's intentions or a predefined format.

Technical challenges may be associated with generating high-fidelity personalized images in a quick and efficient manner. Examples described herein guide a user (e.g., via a real-time camera feed) to provide one or more of the images needed to perform effective personalized output image generation. For example, “selfie” images of different facial expressions of the user and/or images of the user from different angles are captured via the interaction application itself. These images are then automatically processed to obtain the combined identity representation for downstream generation of personalized output images. In this way, an end-to-end process resulting in the personalized output images is streamlined or expedited.

Further technical challenges may arise with respect to the training of machine learning components of an image generation system. One or more of the components often have resource-intensive training requirements. Training all components “from scratch” can be costly and time-consuming. Examples described herein provide efficient training processes that reduce resource requirements.

Efficient training of components of an image generation system can be achieved via additional components that can adapt the image generation system. In some examples, a pre-trained version of the generative machine learning model is provided with pre determined parameters for processing additional image generation controls (e.g., layers for processing text prompts). New parameters are defined to process combined identity representations, and training is performed to adjust the new parameters while keeping the predetermined parameters frozen. These new parameters can be provided by additional components that are “plugged in” to the pre-trained version. In some examples, further new parameters are defined to generate, for a given set of identity representations encoded from respective images of a person, a corresponding combined identity representation for the person. Training to adjust the new parameters and the further new parameters can be performed simultaneously while keeping pre-trained parameters frozen.

Accordingly, in some examples, during training, only certain parameters are adjusted while keeping other parameters frozen. For example, existing parameters of a pre-trained diffusion model can be kept frozen, while new parameters for injecting “image prompts” (e.g., combined identity representations), as well as new parameters for creating these image prompts, can be adjusted during a relatively quick training process.

While examples in the present disclosure focus on capturing human identity features, such as facial features of a person, in a combined identity representation, it is noted that one or more techniques described herein can also be applied to other use-cases. For example, other entities with unique identities or distinguishable characteristics, such as animals, can be provided as inputs to generate combined identity representations, thereby allowing for the generation of output images that depict identities or characteristics of such other entities.

Furthermore, examples in the present disclosure describe the generation of a personalized output image using a combined identity representation associated with a user of an interaction application. In other words, the user of the interaction application is the subject of the combined identity representation and the personalized output image. However, it will be appreciated that the combined identity representation can be associated with another person or entity. For example, the user of the interaction application can provide input images depicting another person or another entity (e.g., their pet) to obtain an output image that is personalized with respect to the other person or entity and not with respect to the user.

### Networked Computing Environment

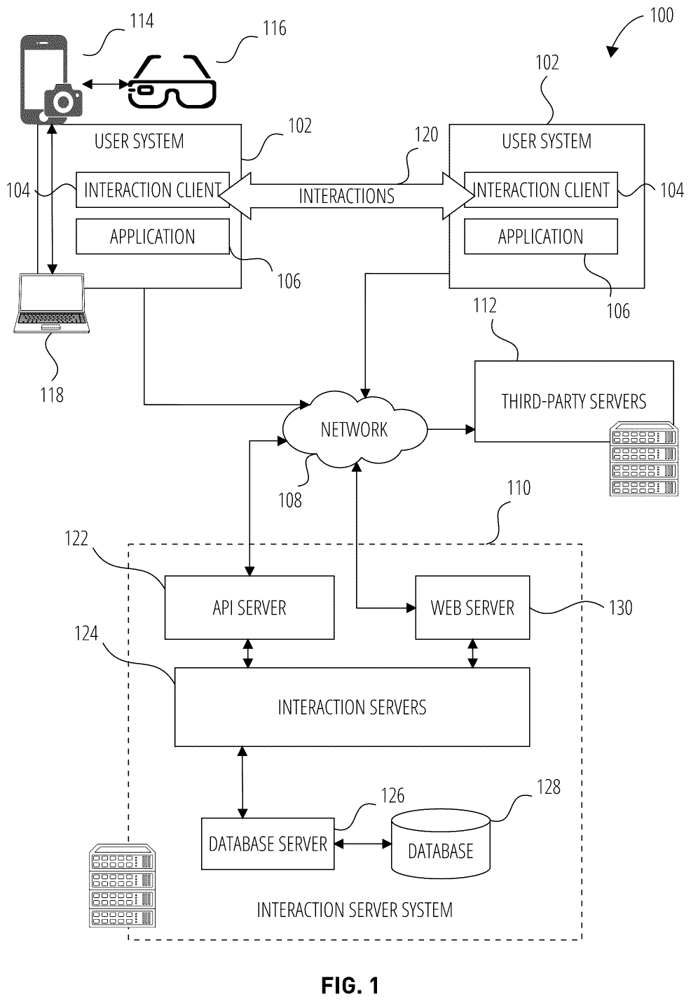

FIG. 1 is a block diagram showing an example interaction system 100 for facilitating interactions (e.g., exchanging text messages, conducting text, audio and video calls, or playing games) over a network. The interaction system 100 includes multiple user systems 102, each of which hosts multiple applications, including an interaction client 104 (as an example of an interaction application) and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112. An interaction client 104 can also communicate with locally hosted applications 106 using Application Programming Interfaces (APIs).

Each user system 102 may include multiple user devices, such as a mobile device 114, head-wearable apparatus 116 (e.g., an extended reality (XR) device, such as XR glasses, that can be worn by the user), and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to deploy particular technology and functionality within the interaction server system 110 initially, but later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, content augmentation (e.g., filters or overlays), message content persistence conditions, entity relationship information, and live event information. Data exchanges within the interaction system 100 are invoked and controlled through functions available via user interfaces of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

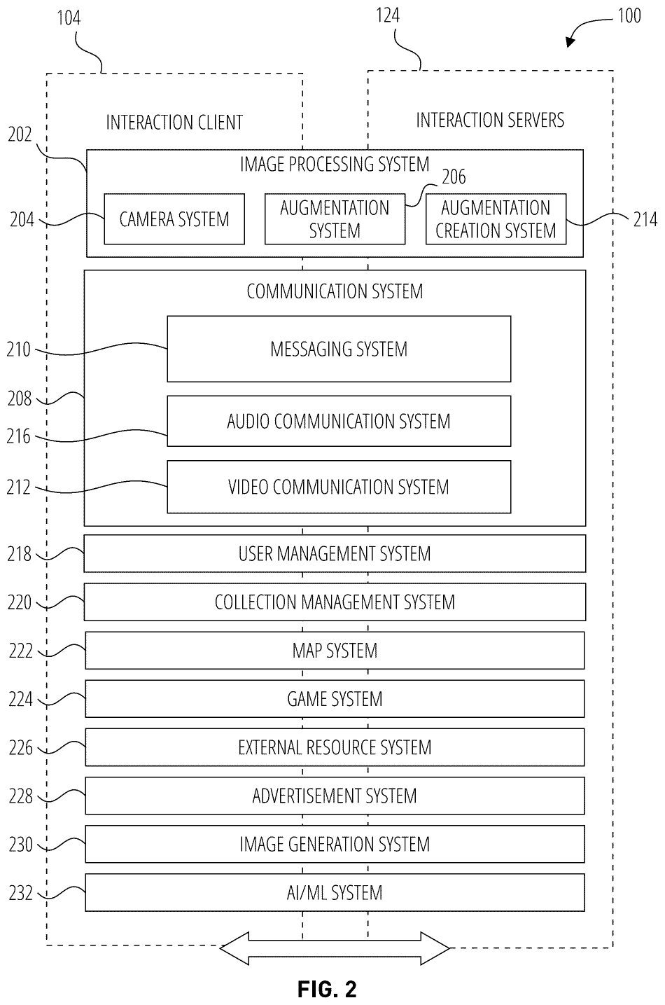

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including, for example, account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 308); the location of friends within an entity relationship graph; opening an application event (e.g., relating to the interaction client 104); or requesting an image to be generated by an automated image generation system. The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a.* ml file), an applet may incorporate a scripting language (e.g., a.* js file or a.json file) and a style sheet (e.g., a.* ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as representational state transfer (REST) or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture. Example subsystems are discussed below.

An image processing system 202 provides various functions that enable a user to capture and augment (e.g., annotate, modify, or edit, or apply a digital effect to) media content associated with a message. A camera system 204 includes control software (e.g., in a camera application) that interacts with and controls hardware camera hardware (e.g., directly or via operating system controls) of the user system 102 to modify and augment real-time images captured and displayed via the interaction client 104.

An augmentation system 206 provides functions related to the generation and publishing of augmentations (e.g., filters or media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example, custom shaders, tracking technology, and templates. In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. In some examples, the messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share their location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An image generation system 230 enables a user of the interaction system 100 to receive an automatically generated image (or a video comprising multiple automatically generated image frames). The image can be generated by the image generation system 230 in response to submission of an instruction and/or prompt via the interaction client 104. The image generation system 230 causes generation of an image (or multiple images) corresponding to a user instruction (e.g., a user prompt and/or other information, such as input images and structural conditions). Image generation may be performed using various AI-implemented image generation techniques. For example, the image generation system 230 may include a multimodal automated image generator providing a machine learning model that can generate output images based on input images and additional image generation control, such as text prompts and/or structural conditions.

In some examples, the image generation system 230 is also responsible for content checking or filtering, such as checking of a prompt for objectionable language or checking of an input image for unwanted content before allowing a new output image to be generated. In some examples, the image generation system 230 provides an automatic prompt generation feature by enabling a user to request a prompt, e.g., a sample text prompt or a suggested text prompt, which can assist the user in obtaining a new output image.

An artificial intelligence and machine learning system 232 provides a variety of services to different subsystems within the interaction system 100. For example, the artificial intelligence and machine learning system 232 operates with the image processing system 202 and the camera system 204 to analyze images and extract information such as objects, text, or faces. This information can then be used by the image processing system 202 to enhance, filter, or manipulate (e.g., apply a visual augmentation to) images. The artificial intelligence and machine learning system 232 may be used by the augmentation system 206 to generate augmented content and augmented reality experiences, such as adding virtual objects or animations to real-world images. The communication system 208 and messaging system 210 may use the artificial intelligence and machine learning system 232 to analyze communication patterns and provide insights into how users interact with each other and provide intelligent message classification and tagging, such as categorizing messages based on sentiment or topic.

The artificial intelligence and machine learning system 232 may also provide chatbot functionality to interactions 120 between user systems 102 and between a user system 102 and the interaction server system 110. The artificial intelligence and machine learning system 232 may work with the audio communication system 216 to provide speech recognition and natural language processing capabilities, allowing users to interact with the interaction system 100 using voice commands. The artificial intelligence and machine learning system 232 may also provide or facilitate generative AI functionality, e.g., allowing a user to generate text, image, or video content based on prompts and/or other instructions. In some examples, the artificial intelligence and machine learning system 232 provide a generative AI assistant that can answer questions provided by the user or otherwise help the user to learn about topics or obtain useful information.

Referring again to the image generation system 230, the artificial intelligence and machine learning system 232 may automatically work with the image generation system 230 to provide AI-related functionality to the image generation system 230. For example, the artificial intelligence and machine learning system 232 can allow the image generation system 230 to utilize a combination of machine learning components or algorithms to synthesize new images. This can include allowing the image generation system 230 to, or assisting the image generation system 230 to encode images to obtain identity representations, combine identity representations to obtain combined identity representations, encode text prompts to obtain text prompt representations, and process identity representations (in some cases together with other image generation controls) to generate personalized output images. In this regard, the image generation system 230 can transmit instructions to the artificial intelligence and machine learning system 232 to execute certain AI-implemented components or process inputs via AI features or algorithms. Accordingly, where AI-related components or functionalities for image generation are described herein with reference to the interaction system 100, such components or functionalities may be provided by the image generation system 230, the artificial intelligence and machine learning system 232, or a combination of the image generation system 230 and the artificial intelligence and machine learning system 232.

### Data Architecture

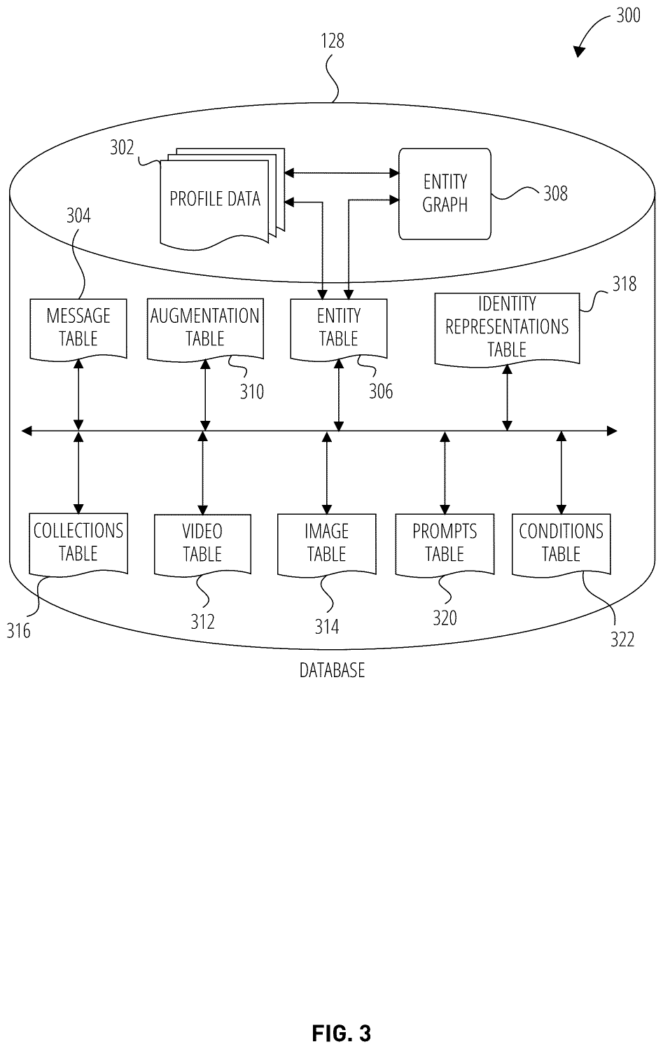

FIG. 3 is a schematic diagram illustrating data structures 300, which may be stored in a database, such as the database 128 of the interaction server system 110, according to certain examples. While the content of the database 128 is shown to comprise multiple tables, it will be appreciated that the data could be stored in other types of data structures (e.g., as an object-oriented database).

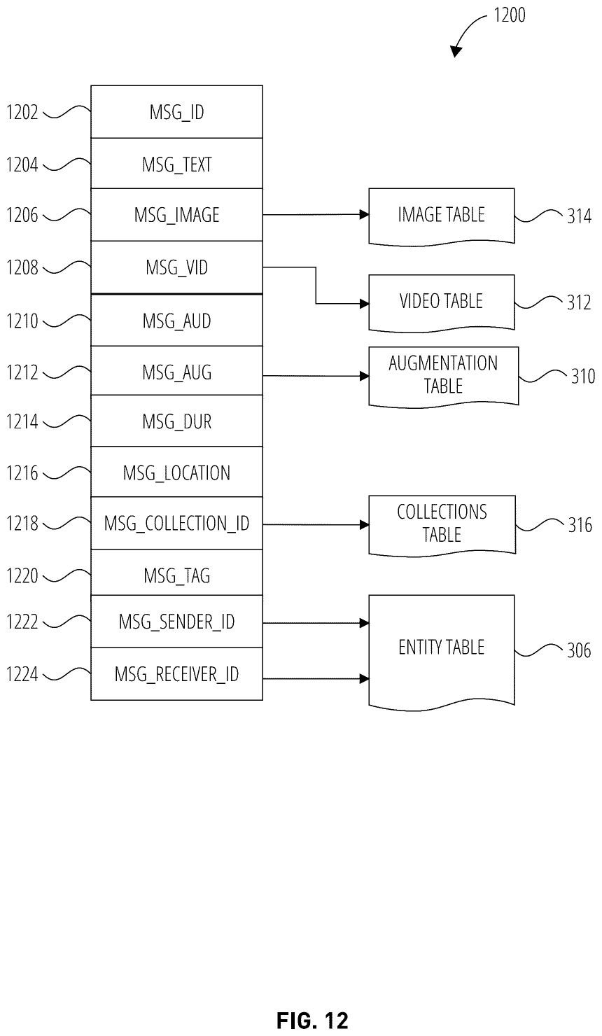

The database 128 includes message data stored within a message table 304. This message data includes, for any particular message, at least message sender data, message recipient (or receiver) data, and a payload. Further details regarding information that may be included in a message, and included within the message data stored in the message table 304, are described below with reference to FIG. 12.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores augmentation data, such as overlays or filters, in an augmentation table 310. The augmentation data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 314 includes augmented reality content items (e.g., corresponding to applying “lenses” or augmented reality experiences). An augmented reality content item may be a real-time special effect and sound that may be added to an image or a video.

A collections table 316 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the interaction client 104 may include an icon that is user-selectable to enable a sending user to add specific content to their personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on their location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various augmentations from the augmentation table 310 with various images and videos stored in the image table 314 and the video table 312.

The image table 314 may also store images uploaded by a user to provide identity information for generating personalized images. For example, the user may upload three input images (e.g., depicting their face from different angles and/or depicting different facial expressions) which are stored in the image table 314 and utilized for downstream automated image generation.

An identity representations table 318 stores identity representations generated based on input images. For example, the image generation system 230 and/or the artificial intelligence and machine learning system 232 encodes input images to obtain identity representations that capture facial features of a user. As described elsewhere herein, the image generation system 230 and/or the artificial intelligence and machine learning system 232 can automatically combine identity representations associated with the same person to obtain a combined identity representation. The identity representations table 318 can also store one or more combined identity representations.

A prompts table 320 may store one or more prompts that are or may be used with respect to the image generation system 230 and/or artificial intelligence and machine learning system 232. For example, the prompts table 320 may store prompts that can be selected by a user (or have previously been selected) for automatic image generation via the image generation system 230, where the interaction client 104 provides the user with access to automatic image generation functionality.

A conditions table 322 may store one or more other conditions that are or may be used with respect to the image generation system 230 and/or artificial intelligence and machine learning system 232. For example, the conditions table 322 may store examples of structural guidance, or previously uploaded structural guidance, that can be selected for automatic image generation via the image generation system 230. Examples of such conditions include structural maps, edge maps, depth maps, or pose maps that guide image generation from a structural or spatial perspective.

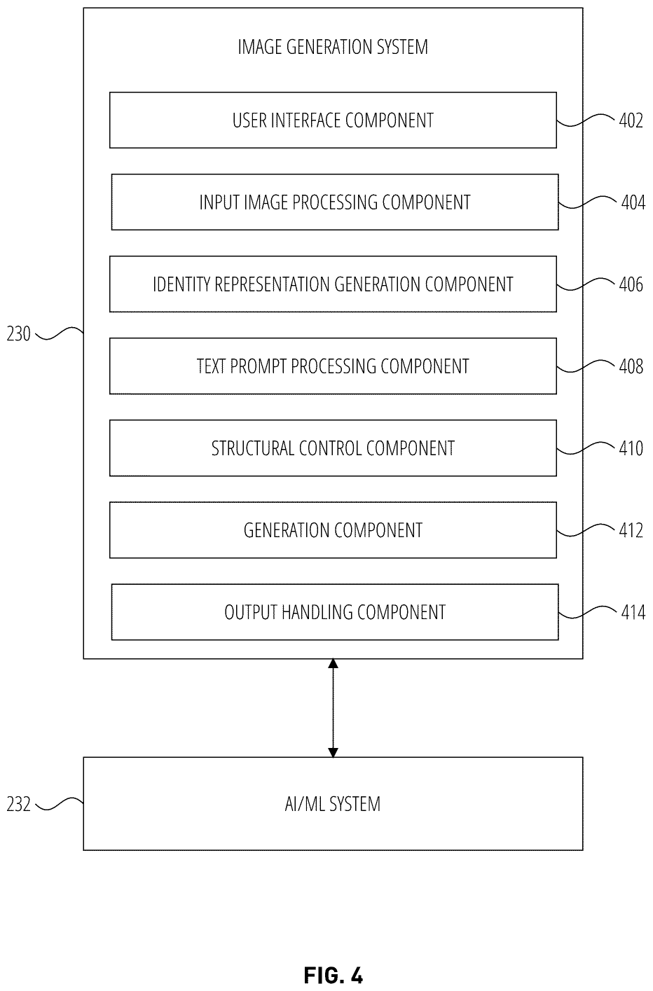

FIG. 4 is a block diagram illustrating components of the image generation system 230 of FIG. 2, according to some examples. FIG. 4 also shows the artificial intelligence and machine learning system 232 of FIG. 2 to illustrate that functions of the image generation system 230 can be facilitated, performed, or supported by the artificial intelligence and machine learning system 232. FIG. 4 illustrates only certain components of the image generation system 230 to illustrate functions and methodologies relating to examples of the present disclosure, and accordingly may omit certain other components.

The image generation system 230 is configured to generate personalized images in an automated manner based on multiple inputs, including, for example, multiple input images and a text prompt. While the image generation system 230 is shown in examples as being part of an interaction system such as the interaction system 100, in other examples the image generation system 230 can form part of other systems, such as content generation systems, scenario building tools, or more general AI services, that do not necessarily provide some or all user interaction features as described with reference to the interaction system 100.

The image generation system 230 is shown in FIG. 4 to include a user interface component 402, an input image processing component 404, an identity representation generation component 406, a text prompt processing component 408, a structural control component 410, a generation component 412, and an output handling component 414.

The user interface component 402 enables interactions between a user of a user system 102 and the image generation system 230. The user interface component 402 is configured to receive user inputs, such as image uploads, text prompts, and selections of desired image attributes. The user interface component 402 facilitates navigation and operation of image generation system 230, providing tools and options, for example via the interaction client 104, that are useful for running or customizing the image generation process.

In some examples, the user interface component 402 provides an automated prompt generator component to allow a user to request a prompt, e.g., a sample text prompt or a suggested text prompt, in response to which the image generation system 230 automatically generates and presents a prompt to the user. The user can use such a prompt as a starting point (or as inspiration) to create a final prompt, or may submit such a prompt directly for image generation. The user interface component 402 also provides an upload component for uploading multiple input images (e.g., images depicting the face of the user from different angles or depicting various facial expressions of the user).

In some examples, the image generation system 230 is configured to prohibit or prevent the user from generating images based on objectionable, sensitive, or unwanted content. To this end, a content moderation engine is used to automatically check and filter prompts (or other inputs, such as input images) containing unwanted content, or including content with context or meaning that is determined to be objectionable. Restricted content can be rejected and/or modified automatically by the image generation system 230 prior to image generation, as described further below.

The input image processing component 404 is responsible for handling and processing image inputs received via the user interface component 402. For example, the input image processing component 404 processes image data received from the user interface component 402 by performing tasks such as image resizing or feature detection. The input image processing component 404 may assign a unique identifier to each image input.

The identity representation generation component 406 analyzes an image to extract detailed identity features, creating an identity representation of a subject in the image. The identity representation generation component 406 works with the artificial intelligence and machine learning system 232 to utilize machine learning algorithms, such as image encoding and/or image feature extracting or projecting algorithms. For example, where the user uploads an image of their own face, the identity representation generation component 406 works with the artificial intelligence and machine learning system 232 to encode the image and generate an identity representation that captures identifying or characteristic features of the face from the image. The user and the subject of the desired output image may be different persons, in which case the user uploads, for example, an image of the face of the relevant subject.

In some examples, the identity representation generation component 406 is also responsible for generating combined identity representations. For example, the identity representation generation component 406 works with the artificial intelligence and machine learning system 232 to merge or combine multiple identity representations, each associated with a respective image of the same subject, into a combined identity representation that captures key and/or consistent facial features that are present across the multiple identity representations, while discarding or deemphasizing other features.

The text prompt processing component 408 handles text inputs received from the user interface component 402. The text prompt processing component 408 processes these inputs (e.g., via a text encoder provided by the artificial intelligence and machine learning system 232) to extract relevant information and parameters that will guide the image generation process. This component ensures that the text prompts are correctly interpreted to align the generated images with the user's textual descriptions and intentions.

In some examples, the image generation system 230 includes a structural control component 410 in addition to, or as an alternative to, the text prompt processing component 408. The structural control component 410 allows for control over spatial or structural aspects of the generated images. For example, by allowing the artificial intelligence and machine learning system 232 to receive and process conditions such as edge maps, pose maps, or depth maps, the structural control component 410 allows for the imposition of specific layout, composition, or style parameters, which are used by the generation component 412 during the image synthesis process. Structural conditions may be provided by the user or predefined within the interaction system 100. In some examples, the structural control component 410 thus enables users to exert finer control over the appearance and structure of the generated images.

The generation component 412 uses the relevant inputs, such as a combined identity representation, a processed text prompt and/or other structural conditions, to generate personalized output images (also referred to as artificial or synthesized images). The generation component 412 works with the artificial intelligence and machine learning system 232 to employ a generative machine learning model that synthesizes inputs into final image outputs that incorporate both the identity of the relevant subject and the thematic elements derived from the text prompts. This component is key to realizing the personalized aspects of the generated images.

The generation component 412 can, for example, be configured to perform one or more of:
Generation of an output image based on an image prompts alone (e.g., automatic generation of a personalized output image conditioned only on a combined identity representation.)
Generation of an output image based on an image prompt and a text prompt;
Generation of an output image based on an image prompt and another image generation control (e.g., a structural condition); or
Generation of an output image based on an image prompt, a text prompt, and one or more other image generation controls.

The output handling component 414 is responsible for handling personalized output images produced via the generation component 412. The output handling component 414 may prepare images for presentation or delivery to the user, performing tasks such as formatting, compression, or transmission. The output handling component 414 ensures that the generated images are delivered in formats suitable for user consumption and in accordance with system performance standards. The output handling component 414 can operate with the user interface component 402 to present a personalized output image in a user interface of the interaction client 104.

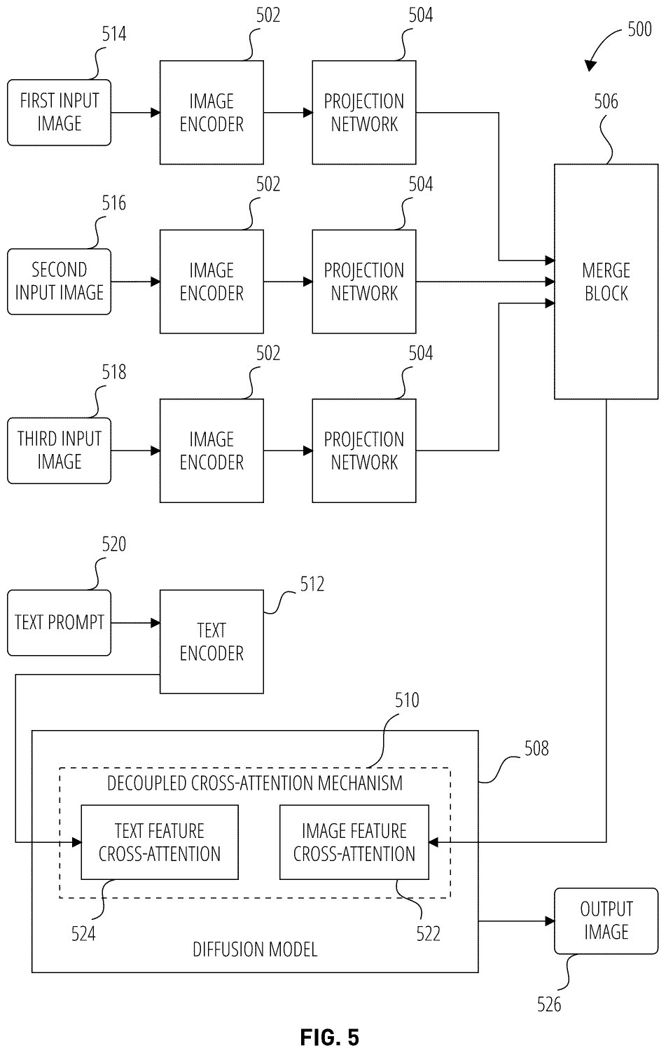

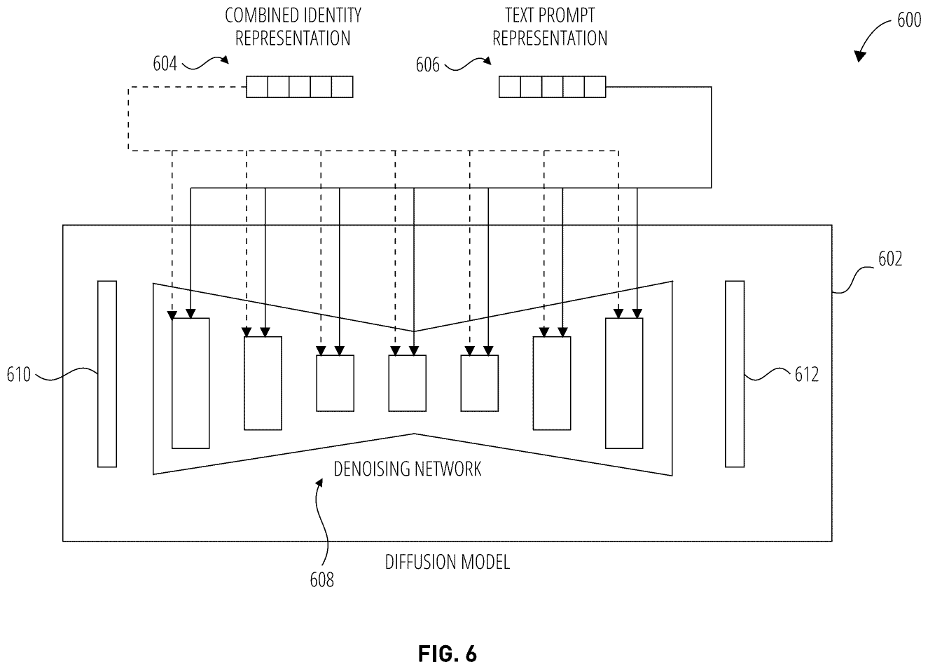

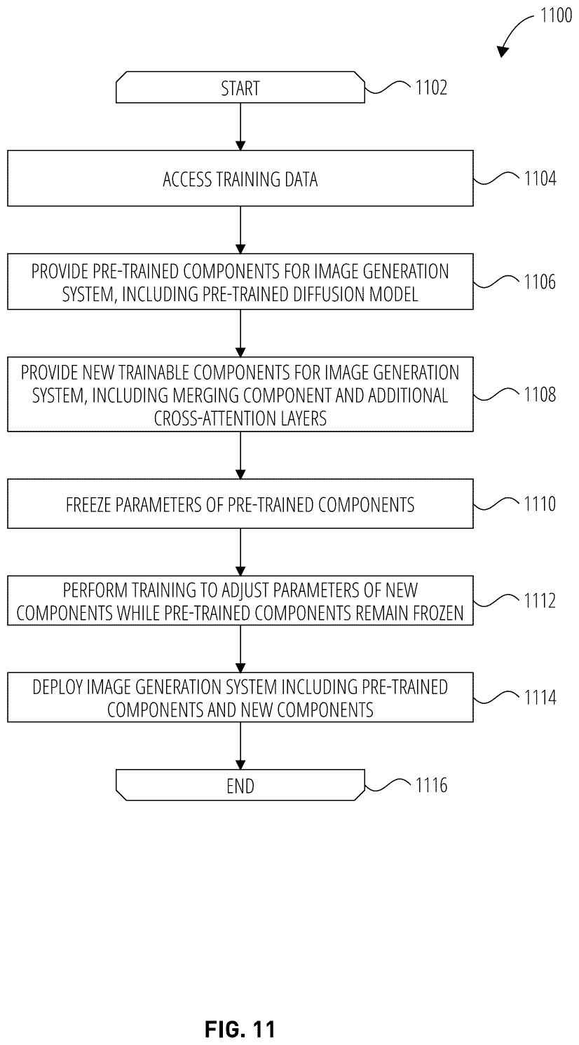

In some examples in the present disclosure, including those described with reference to FIG. 5, FIG. 6, and FIG. 11, a diffusion model is employed by the image generation system 230 to generate images. A diffusion model is a type of generative machine learning model that can be used to generate images conditioned on one or more inputs. It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise images into desired output images. A diffusion model can be fed with input data (e.g., text describing the desired images) and the corresponding output images, and the parameters of the model are adjusted iteratively to improve its ability to generate accurate or good quality images.

Once trained, in order to generate an image, the diffusion model uses the relevant input and applies the trained sequence of transformations to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image is intended to represent a visual interpretation of the input.

In some examples, a diffusion-based model may take an image prompt as an input to produce a generated image that is conditioned on the image prompt (for example, in addition to a text prompt). A diffusion-based model may also take structural conditions as inputs, e.g., to guide the model to produce a particular shape, structure, or layout. In some examples, the model commences its diffusion process with pure noise and progressively refines the generated image, while in other cases one or more inputs (e.g., structural conditions) may allow for some earlier steps to be skipped, e.g., by commencing with certain input mixed with Gaussian noise.

In some examples, to enhance the capabilities of a diffusion model, additional components can be integrated into the system. ControlNet is an example of a component that can be trained alongside or integrated with a pre-trained diffusion model to introduce additional control over the generation process without the need to retrain the entire model “from scratch.” ControlNet operates by injecting condition-specific features into the diffusion process at various stages. For instance, if the desired output is an image of a subject in a landscape with a specific type of building, ControlNet can guide the diffusion model to focus on generating the building in a specified style during the image synthesis process.

While certain examples described herein utilize a diffusion-based model to generate images, other types of models may be employed to generate images in other examples, such as GANs, Variational Autoencoders (VAEs), autoregressive models, or other neural networks.

Generally, in order to train a model to provide one or more functionality as described in examples of the present disclosure, training data in the form of prompts, images, and/or metadata may be used. A training data set for a generative model may include thousands or millions of images or sets of images paired. Training data may include real and/or synthetic (e.g., AI-generated) data. In some examples, a training data set includes, for a particular image, a caption/prompt. The caption/prompt can be from real data, or can be generated by an automated caption generator, such as an image-to-text model. These captions may be used in the training process. A caption can, for example, be automatically generated for an image using a multimodal encoder-decoder.

In some examples, one or more components are added to a diffusion model to enable the diffusion model to process inputs in a many-to-one manner. The components may include a merging component, such as a merge block, that is configured to merge multiple identity representations containing identity information, before identity information is fed into the diffusion model. Furthermore, the components may add layers to the diffusion model to enable it to process both image features and text features in an effective manner. By using such components, performance of a diffusion model with respect to personalized image generation can be improved without extensive training or retraining.

FIG. 5 illustrates an image generation process 500 that utilizes multiple AI-implemented components, according to some examples. In some examples, the image generation process 500 is performed by the image generation system 230 and/or the artificial intelligence and machine learning system 232 of FIG. 2 and FIG. 4.

At a high-level, the image generation process 500 involves separately processing each of a plurality of input images via an image encoder 502 and a projection network 504 to obtain identity representations. The identity representations are combined by a merge block 506 to obtain a combined identity representation, which is fed to a diffusion model 508 via a decoupled cross-attention mechanism 510. The decoupled cross-attention mechanism 510 allows the diffusion model 508 to process the combined identity representation and text features. The text features are processed via a text encoder 512.

The components mentioned above work together to process image and text inputs, ultimately synthesizing these inputs into a final output image that reflects both the identity of a subject and aspects specified by a user via a text prompt, such as thematic, stylistic, spatial, structural, or scenario-related guidance or instructions.

The image encoder 502 is configured to extract image features from input images. For example, a pre-trained CLIP (Contrastive Language-Image Pre-training) encoder can be utilized as the image encoder 502, either as is or with additional fine-tuning to focus on specific features (e.g., facial features). The image encoder 502 may encode images into a vector space, e.g., to produce a feature vector that represents the visual content.

In the image generation process 500 of FIG. 5, the image encoder 502 receives three different input images: a first input image 514, a second input image 516, and a third input image 518. Each of the input images depicts features of a subject, such as the face of the subject. However, it is noted that the input images are not the same and thus depict features of the subject at least somewhat differently. For example, a user of the interaction client 104 captures three different “selfie” images and uploads them to the image generation system 230 for processing. It is noted that while the image generation process 500 utilizes three input images, in other examples, two images or more than three input images (e.g., five input images or seven input images) can also be utilized.

Each image is encoded separately to extract relevant features that represent visual information pertinent to the identity of the subject depicted in the images. The encoded features from each image are then forwarded to the projection network 504. The projection network 504 transforms the encoded image features into a format or structure suitable for further processing. In some examples, the projection network 504 is trained to project image features into a sequence with a desired length. For example, the projection network 504 may transform the encoded image features to have a dimension matching that of the text features fed into the diffusion model 508 from the text encoder 512. In some examples, the projection network 504 includes a linear layer and a layer normalization component.

For each of the first input image 514, the second input image 516, and the third input image 518, the image features as obtained via the image encoder 502 and the projection network 504 are referred to as a respective identity representation. The identity representation captures characteristics or attributes of the subject as extracted from the particular input image. Since the images all depict the same subject, but are not identical, the identity representations may also be similar but not identical (with variations depending on the extent of differences between images). The merge block 506 receives the respective identity representations from the projection network 504 and combines them into a single, unified set of image features. This merging process causes synthesizing of the identity information from multiple images, creating a comprehensive, accurate, and/or consistent representation that captures the essence of the subject's identity across different visual contexts.

For instance, the merge block 506 might process identity representations from images showing different facial expressions of a person to create a combined identity representation that reflects the person's appearance across these varying expressions. As another example, the subject may have a blemish on their face or a shadow obscuring part of their face in the first input image 514, but not in the second input image 516 and the third input image 518.

The merge block 506 is configured to capture essential and non-temporary features and may thus disregard or deemphasize the blemish or shadow, thereby creating a combined identity representation that better represents unique or characterizing features of the subject (which would be less likely in a system designed to process, for example, only the first input image 514 and no additional input images). Thus, the image generation process 500 leverages multiple “reference images” of a subject instead of a single image, which may result in technical challenges.

In the case of FIG. 5, the merge block 506 includes one or more Multi-Layer Perceptrons (MLPs) that are trained to generate the combined identity representation. In other examples, the merge block 506 includes other trainable components (e.g., a linear layer and layer normalization component) or non-trainable components (e.g., a rules-based component that applies a predetermined formula to merge or combine the identity representations).

The combined representation can then be used to generate personalized images that reflect the person's identity. The diffusion model 508 receives the combined identity representation from the merge block 506 and utilizes the combined identity representation to automatically generate an output image 526.

In addition to the combined identity representation, the diffusion model 508 receives a text prompt representation. The text prompt representation is generated by the text encoder 512 based on a text prompt that, for example, describes a scenario and/or style for the output image 526. In some examples, the user provides the text prompt via the interaction client 104.

In some examples, the text encoder 512 is a CLIP text encoder. The text encoder 512 processes the text prompt 520, converting textual information (e.g., “me at the beach in a photorealistic style”) into a set of text features that describe, for example, the desired thematic or stylistic elements of the output image.

The decoupled cross-attention mechanism 510 provides separate pathways for processing image and text features, namely image feature cross-attention 522 and text feature cross-attention 524, as shown in FIG. 5. The decoupled cross-attention mechanism 510 separates attention processes for different data modalities, allowing each to contribute effectively to the final output. In some examples, both the identity representation and the text prompt representation are fed as latent-space representations via the decoupled cross-attention mechanism 510. FIG. 6 illustrates a decoupled cross-attention mechanism, according to some examples, in more detail.

The diffusion model 508 uses a diffusion process to generate the output image 526. Based on the combined identity representation, the output image 526 reflects the identity of the subject. Since the text prompt is also processed by the diffusion model 508, thematic or stylistic preferences are also incorporated into the output image 526. The output image 526 can thus be referred to as a personalized output image.

FIG. 6 is a diagram 600 that illustrates a decoupled cross-attention mechanism of a diffusion model 602, according to some examples. In some examples, the diffusion model 602 is used in the image generation process 500 of FIG. 5 and is thus (in such examples) similar to the diffusion model 508 described with reference to FIG. 5. In some examples, the diffusion model 602 is deployed via the image generation system 230 and/or the artificial intelligence and machine learning system 232 of FIG. 2 and FIG. 4.

The architecture of the diffusion model 602 is based on a U-Net architecture with attention layers. The diffusion model 602 is configured to receive and process a combined identity representation 604 and a text prompt representation 606, respectively, via a denoising network 608, as shown in FIG. 6. The denoising network 608 is trained to transform a noised image 610 (or partially noised image) into a denoised image 612 in a series of steps, as described elsewhere herein.

One approach to enabling the diffusion model 602 to handle both image-based features (e.g., the combined identity representation 604) and text-based features (e.g., the text prompt representation 606) is to concatenate these features into the same cross-attention layers of the diffusion model 602. However, this may prevent the diffusion model 602 from capturing fine-grained features from input images. Instead, in some examples, the diffusion model 602 is adapted from a pre-trained model by embedding the image-based features via separate cross-attention layers that are different than the cross-attention layers handling the text-based features.

In some examples, the diffusion model 602 is obtained by taking a pre-trained diffusion model with cross-attention layers that handle the text-based features, and adding components in the form of new cross-attention layers for the image-based features. In some examples, a new cross-attention layer is added for each cross-attention layer in the original denoising network 608 (e.g., U-Net model component).

By processing the combined identity representation 604 and the text prompt representation 606 via separate layers of the diffusion model 602 (instead of, for example, concatenating them and embedding them in the same layers), the accuracy and fidelity of a subject's portrayal (as captured in the combined identity representation 604) can be better maintained. Accordingly, the cross-attention mechanism depicted in FIG. 6 can be classified as “decoupled” since it separates cross-attention layers for text-based features (e.g., text prompts) and image-based features (e.g., image prompts as merged into a combined representation).

While certain components described with reference to FIG. 5 and FIG. 6 are used to add the ability to handle image-related features within a diffusion model, it is noted that a diffusion model can also be adapted to handle one or more additional or alternative image generation controls. For example, and as mentioned, a component such as ControlNet can be integrated with the diffusion model 508 of FIG. 5 or the diffusion model 602 of FIG. 6 to provide one or more additional controls or conditions (e.g., the ability to handle human pose maps in addition to identity representations to guide personalized output image generation).

One or more of the components shown in the drawings, such as in FIG. 2, FIG. 4, FIG. 5, or FIG. 6, may be implemented using hardware (e.g., a processor of a machine) or a combination of hardware and software. For example, a component described herein may configure a processor to perform the operations described herein for that component. Moreover, two or more of these components may be combined into a single component, and the functions described herein for a single component may be subdivided among multiple components. Furthermore, according to various examples, components described herein as being implemented within a single machine, database, or device may be distributed across multiple machines, databases, or devices.

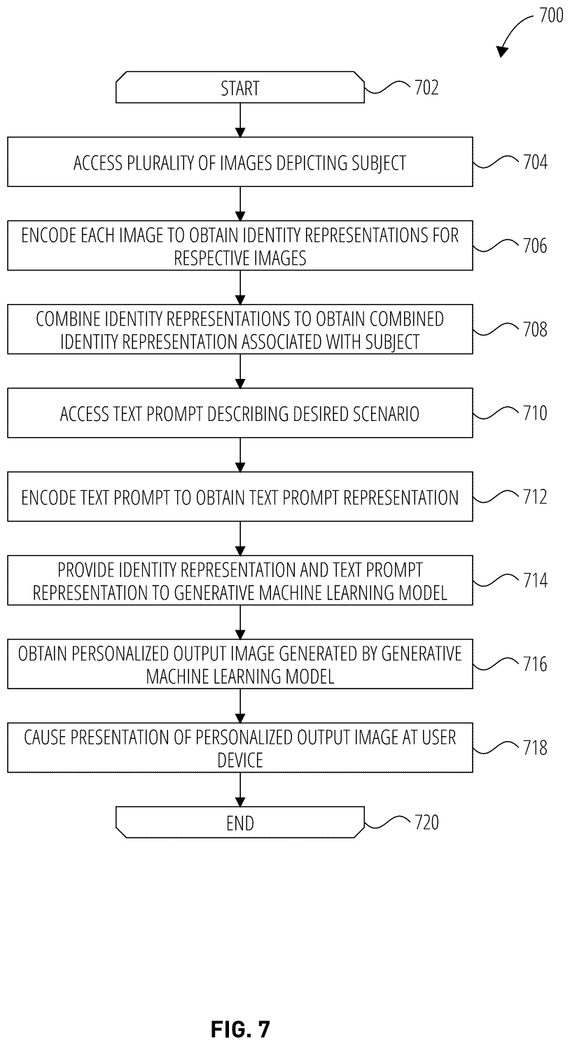

FIG. 7 illustrates operations of a method 700 suitable for encoding a plurality of input images and generating a personalized output image, according to some examples. In some examples, the method 700 is performed by components of the interaction system 100, including the image generation system 230 of FIG. 2 and FIG. 4. Accordingly, the image generation system 230 is referenced below to describe the method 700 in a non-limiting manner. The image generation system 230 can communicate with and/or instruct the artificial intelligence and machine learning system 232 to perform one or more operations of the method 700 of FIG. 7.

The method 700 commences at opening loop operation 702, and proceeds to operation 704 in which the image generation system 230 accesses a plurality of input images (e.g., via the input image processing component 404). The input images are provided by a user via the interaction client 104 (as an example of an interaction application), and all depict a subject (e.g., the user or another person). For example, the user uses their user system 102 (e.g., the mobile device 114 or some other user device) to upload three input images via an image upload user interface provided by the interaction client 104. The image upload user interface can be provided as part of an onboarding process related to a personalized image generation feature.

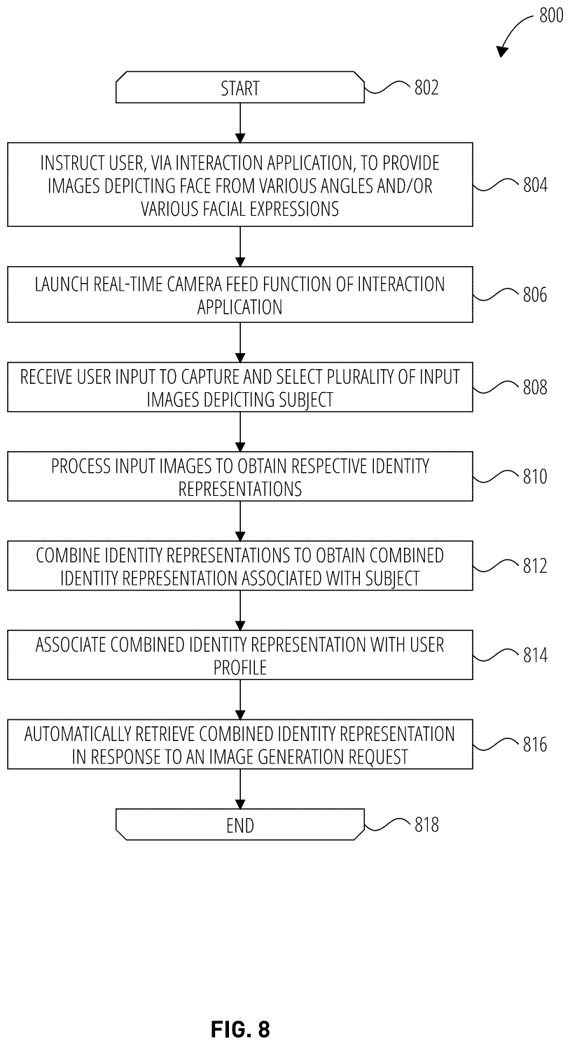

In some examples, the image generation system 230 automatically instructs or requests, via the interaction client 104, the user to provide a variety of input images (e.g., via the user interface component 402). For example, the user is instructed, via the image upload user interface, to provide at least three images of the same subject or the same part of the subject (e.g., the face), but with a degree of variation to enable the image generation system 230 to analyze different facial expressions, poses, or angles to better “understand” characterizing features of the subject. This can result in downstream generation of a combined identity representation that better captures features of the subject. To facilitate image capturing, in some examples, the image generation system 230 causes launching of a real-time camera feed of the interaction client 104 at the user system 102, as described in more detail with reference to FIG. 8.

At operation 706, the image generation system 230 encodes each respective input image to obtain an identity representation for the input image (e.g., via the identity representation generation component 406). At operation 708, the image generation system 230 combines the identity representations to obtain a combined identity representation associated with the subject. In some examples, identity representations and the combined identity representation are generated as described in the image generation process 500 of FIG. 5.

The method 700 proceeds to operation 710, where the image generation system 230 accesses a text prompt. For example, the user provides a text prompt via the interaction client 104 to describe a scenario and, in some cases, stylistic or structural instructions (e.g., “me relaxing at the beach in a photorealistic style”). In some examples, the interaction client 104 provides a prompt selection interface. The prompt selection interface may include a text input section such as an input text box, allowing the user to enter or select the prompt. The prompt may be a phrase, a sentence, or multiple sentences describing what the user wants to see in the image.

In some examples, the combined identity representation is generated by the image generation system 230 in response to the user providing the input images during the onboarding process, while the text prompt is subsequently provided and triggers the image generation system 230 to initiate image generation. For example, the user provides the text prompt and selects a “generate image” button, or similar, in the user interface of the interaction client 104, thereby triggering image generation.

At operation 712, the image generation system 230 obtains the text prompt as provided by the user, and encodes the text prompt to obtain a text prompt representation (e.g., via the text prompt processing component 408). The combined identity representation and the text prompt representation are provided to a generative machine learning model, such as the diffusion model 508 of FIG. 5 (e.g., via the generation component 412), at operation 714. In some examples, the combined identity representation and the text prompt representation are routed separately via a decoupled cross-attention mechanism, as described with reference to FIG. 5 and FIG. 6.

The generative machine learning model processes the inputs and generates a personalized output image (e.g., an image of an AI-generated person that resembles the subject in the input images and that is shown to be relaxing on a beach in accordance with the text prompt). The image generation system 230 obtains the personalized output image at operation 716 and then causes presentation of the personalized output image at a user device, such as the user system 102 of FIG. 1, at operation 718. The method 700 concludes at closing loop operation 720.

It will be appreciated that the generative machine learning model can generate multiple images to provide the user with options to choose from. In some examples, the image generation system 230 causes presentation of a plurality of candidate images, all based on the same text prompt and combined identity representation combination. The user is able to view the candidate images on their user device (e.g., the user system 102) and select one or more of them.

By using combined identity representations in an automated image generation process, the interaction system 100 can provide high-fidelity, personalized output images that reflect features of a subject, such as the facial features of a user of the interaction client 104. The selected personalized output image can be used for various purposes. For example, the image generation system 230 can cause the personalized output image to be stored in association with a user profile of the user (e.g., in the database 128) in the context of the interaction system 100. The personalized output image can, for example, be stored as a profile image, a wallpaper, an avatar, or the like. The personalized output images can be applied in various experiences provided by the interaction system 100, such as personalized augmented reality experiences (e.g., an augmented reality video or game) or themed content experiences.

The personalized output images can be useful in features of the interaction system 100 that benefit from a high level of realism or a high level of personalization. In some examples, a user is enabled to obtain a highly personalized avatar that better represents their physical appearance, for use in interactions with other users in the context of the interaction system 100. The personalized output image can also be shared via the interaction client 104 with other users of the interaction system 100.

Accordingly, while not shown in FIG. 7, the method 700 can include, in some examples, one or more of:
Automatically applying the personalized output image to the user profile of the user in the interaction system 100;
Automatically applying the personalized output image in an augmented reality feature of the interaction system 100; or
Causing the personalized output image to be communicated to other users via respective interaction clients 104.

FIG. 8 illustrates operations of a method 800 suitable for automatically guiding a user of an interaction application to provide a plurality of input images used to generate a combined identity representation associated with a subject, according to some examples. In some examples, the method 800 is performed by components of the interaction system 100, including the image generation system 230 of FIG. 2 and FIG. 4. Accordingly, the image generation system 230 is referenced below to describe the method 800 in a non-limiting manner. The image generation system 230 can communicate with and/or instruct the artificial intelligence and machine learning system 232 to perform one or more operations of the method 800 of FIG. 8.

The method 800 commences at opening loop operation 802, and proceeds to operation 804 in which the image generation system 230 automatically instructs or requests, via the interaction client 104 (as an example of an interaction application), the user to provide multiple input images (e.g., via the user interface component 402). In the method 800, the interaction client 104 specifically indicates to the user that multiple images (e.g., 3 or at least 3) should be uploaded and that the images should depict the face of the subject from various angles and/or should depict various facial expressions.

In some examples, the user uploads the images from a storage component of their user system 102, or accesses a cloud-based storage to retrieve the images. In other examples, and as is the case in the method 800 of FIG. 8, the user opts to capture the images via the interaction client 104. For example, the user selects a “capture images now” option in a user interface of the interaction client 104. The image generation system 230 then causes a real-time camera feed of the interaction client 104 to be launched at operation 806, allowing the user to capture and select images.

In some examples, the real-time camera feed is presented together with instruction messages that guide the capturing process. For example, the user interface presents a sequence of messages indicating “take a selfie while smiling,” then “take a selfie while frowning,” and then “take a selfie with a neutral expression,” thereby enabling the image generation system 230 to obtain three different input images.

Having a degree of variation in the input images can facilitate analyzing and processing, by the image generation system 230, of different facial expressions, poses, or angles to better “understand” characterizing features of the subject. This can result in downstream generation of a combined identity representation that better captures features of the subject. However, in other examples, the user is not requested or instructed to provide a variety of images (but still has to provide multiple images to enable effective combined identity representation generation).

In some examples, the image generation system 230 processes each input image submitted by the user using computer vision techniques to determine (e.g., via the input image processing component 404) whether the input image is suitable for use in generating a combined identity representation. For example, the image generation system 230 checks whether the input image depicts the relevant body part (e.g., the face), whether the lighting is suitable for feature extraction, or, where relevant, whether the image depicts the subject in a requested pose, with a requested facial expression, or from a requested angle. In some examples, the image generation system 230 automatically rejects an unsuitable or sub-optimal image and causes the user to receive a message, via the interaction client 104, indicating that they should upload a new image.

Once the user has captured the input images, the user confirms their selected input images via the user system 102. The image generation system 230 receives the user input (e.g., via the user interface component 402) indicating that the user has captured and selected the necessary input images at operation 808. The image generation system 230 processes each input image to obtain an identity representation at operation 810, and, at operation 812, combines the identity representations to obtain a combined identity representation associated with the subject (e.g., via the identity representation generation component 406). In some examples, identity representations and the combined identity representation are generated as described in the image generation process 500 of FIG. 5.

The image generation system 230 then automatically associates the combined identity representation with a user profile of the user at operation 814. For example, the image generation system 230 stores the combined identity representation in the database 128 of FIG. 1 in association with the user profile. This enables the image generation system 230 to automatically retrieve, at a future point in time and as shown in operation 816 of the method 800, the relevant combined identity representation in response to a request by the same user to generate a personalized output image.

For example, the user might upload the input images as part of an onboarding or initialization process of a personalized output image generation feature, and then close the interaction client 104. At this point in time, the image generation system 230 can already process the input images to obtain the combined identity representation. At a future point in time, the user opens the interaction client 104 again and enters a text prompt to trigger image generation. The image generation system 230 can then efficiently utilize the combined identity representation and the text prompt to generate a new personalized output image in a rapid manner, without having to request new input images from the user. The method 800 concludes at closing loop operation 818.

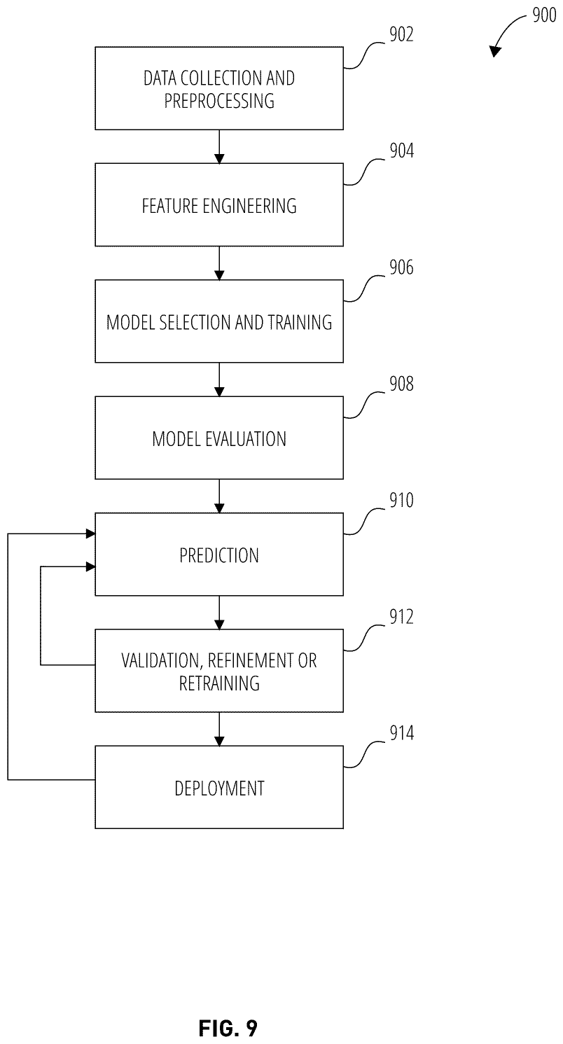

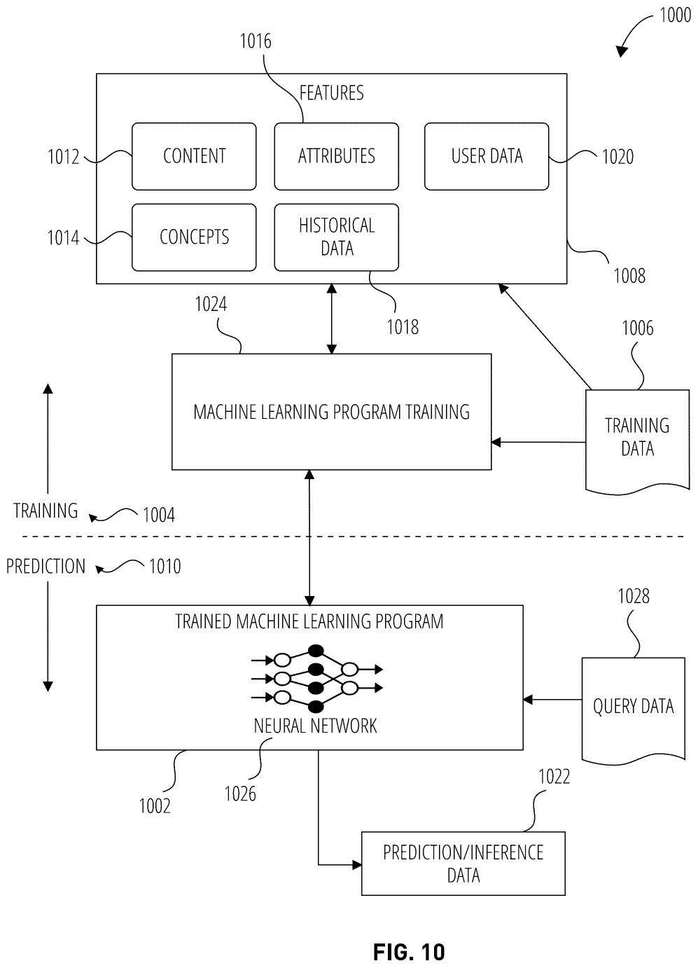

FIG. 9 is a flowchart depicting a machine learning pipeline 900, according to some examples. The machine learning pipeline 900 may be used to generate a trained model, for example, the trained machine learning program 1002 shown in the diagram 1000 of FIG. 10.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data.

Principles discussed herein for one machine learning algorithm can be applied to at least some other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 1002 may include multiple phases that form part of the machine learning pipeline 900, including for example the following phases illustrated in FIG. 9:
Data collection and preprocessing 902: This phase may include acquiring and cleaning data to ensure that it is suitable for use in the machine learning model. This phase may also include removing duplicates, handling missing values, and converting data into a suitable format.
Feature engineering 904: This phase may include selecting and transforming the training data 1006 to create features that are useful for predicting the target variable. Feature engineering may include (1) receiving features 1008 (e.g., as structured or labeled data in supervised learning) and/or (2) identifying features 1008 (e.g., unstructured or unlabeled data for unsupervised learning) in training data 1006.
Model selection and training 906: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 908: This phase may include evaluating the performance of a trained model (e.g., the trained machine learning program 1002) on a separate testing dataset. This phase can help determine if the model is overfitting or underfitting and determine whether the model is suitable for deployment.
Prediction 910: This phase involves using a trained model (e.g., trained machine learning program 1002) to generate predictions on new, unseen data.
Validation, refinement or retraining 912: This phase may include updating a model based on feedback generated from the prediction phase, such as new data or user feedback.
Deployment 914: This phase may include integrating the trained model (e.g., the trained machine learning program 1002) into a more extensive system or application, such as a web service, mobile app, or Internet of Things (IoT) device. This phase can involve setting up APIs, building a user interface, and ensuring that the model is scalable and can handle large volumes of data.

FIG. 10 illustrates further details of two example phases, namely a training phase 1004 (e.g., part of model selection and training 906) and a prediction phase 1010 (part of prediction 910). Prior to the training phase 1004, feature engineering 904 is used to identify features 1008. This may include identifying informative, discriminating, and independent features for effectively operating the trained machine learning program 1002 in pattern recognition, classification, and regression. In some examples, the training data 1006 includes labeled data, known for pre-identified features 1008 and one or more outcomes. Each of the features 1008 may be a variable or attribute, such as an individual measurable property of a process, article, system, or phenomenon represented by a data set (e.g., the training data 1006). Features 1008 may also be of different types, such as numeric features, strings, and graphs, and may include one or more of content 1012, concepts 1014, attributes 1016, historical data 1018, and/or user data 1020, merely for example.

In training phase 1004, the machine learning program may use the training data 1006 to find correlations among the features 1008 that affect a predicted outcome or prediction/inference data 1022. With the training data 1006 and the identified features 1008, the trained machine learning program 1002 is trained during the training phase 1004 during machine learning program training 1024. The machine learning program training 1024 appraises values of the features 1008 as they correlate to the training data 1006. The result of the training is the trained machine learning program 1002 (e.g., a trained or learned model).

Further, the training phase 1004 may involve machine learning in which the training data 1006 is structured (e.g., labeled during preprocessing operations). The trained machine learning program 1002 may implement a neural network 1026 capable of performing, for example, classification or clustering operations. In other examples, the training phase 1004 may involve deep learning, in which the training data 1006 is unstructured, and the trained machine learning program 1002 implements a deep neural network 1026 that can perform both feature extraction and classification/clustering operations.

In some examples, a neural network 1026 may be generated during the training phase 1004, and implemented within the trained machine learning program 1002. The neural network 1026 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1026 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1026 may also be one of several different types of neural networks, such as a single-layer feed-forward network, a MLP, an Artificial Neural Network (ANN), a RNN, a Long Short-Term Memory Network (LSTM), a Bidirectional Neural Network, a symmetrically connected neural network, a Deep Belief Network (DBN), a CNN, a GAN, an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a transformer network, merely for example.

In addition to the training phase 1004, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 1010, the trained machine learning program 1002 uses the features 1008 for analyzing query data 1028 to generate inferences, outcomes, or predictions, as examples of a prediction/inference data 1022. For example, during prediction phase 1010, the trained machine learning program 1002 generates an output. Query data 1028 is provided as an input to the trained machine learning program 1002, and the trained machine learning program 1002 generates the prediction/inference data 1022 as output, responsive to receipt of the query data 1028.

In some examples, the trained machine learning program 1002 is a generative artificial intelligence (AI) model. Generative AI is a term that may refer to any type of artificial intelligence that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. To perform image generation, the generator may generate images based on text prompts and/or other conditions, and the discriminator may evaluate the generated images for realism and/or other metrics, depending on the implementation. The generator and discriminator are trained simultaneously to generate images aimed at closely matching the input/s. The generator generates an image that is intended to deceive the discriminator into designating the image as “real,” while the discriminator generates an image to evaluate the realism of the generator's output. In this way, both networks can be optimized towards their objectives and improve the quality of the generated images.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. In image generation, a VAE may include an unsupervised machine learning program that generates an image by processing input and mapping it to a latent space representation. The latent space representation may then be used to generate an image that corresponds to the input. VAEs are designed to learn the distribution of a dataset and apply that to generate new images likely to conform more closely to the dataset.
Diffusion models, as described in greater detail above, are generative models that generate images by diffusing noise over time. The program may take in a text prompt and/or other input and generate a noise vector, which is then diffused over a set number of time steps to generate an image.
Autoregressive models generate images pixel by pixel, where each pixel is generated based on the previous pixels. Autoregressive models may be trained, for example, using maximum likelihood estimation (MLE) to learn the conditional probability distribution of each pixel in an image given its previous pixels.

In generative AI examples, the prediction/inference data 1022 may include predictions, translations, summaries, answers, media content (e.g., images or videos), or combinations thereof. In some examples, a trained machine learning program 1002 can be used for automated image generation as described in the present disclosure. Automated image generation can be achieved using different types of machine learning programs (or models). As mentioned, examples of these include VAEs, GANs, autoregressive models, and diffusion models.

FIG. 11 illustrates a method 1100 suitable for integrating additional components into a pre-trained diffusion model and training the additional components to adjust parameters thereof for personalized image generation, according to some examples. In the method 1100, the pre-trained diffusion model is integrated with additional components, including a merge block and additional cross-attention layers for the diffusion model, to provide the ability to handle image prompts in the form of combined identity representations without having to retrain or fine-tune original parameters of the pre-trained diffusion model. The example training approach utilizes relatively lightweight components to achieve a high degree of control and fidelity in personalized image generation.

In the method 1100 of FIG. 11, an image generation system is configured to generate personalized output images depicting persons, and specifically faces of persons. Accordingly, the “subjects” referred to below are persons, and the training data includes images depicting faces of persons. It will, however, be appreciated that aspects of the method 1100 can also be applied to configure an image generation system for the generation of other types of images, such as images of the full body of a person, images of animals, or images of other entities that have unique or distinguishable identities or characteristics. Since such types of images are all intended to capture a unique or distinguishable identity or characteristics, they can be classified as personalized output images.

Referring now specifically to FIG. 11, the method 1100 commences at opening loop operation 1102, and proceeds to operation 1104 in which training data is accessed. In some examples, the training data includes multiple sets of training items. Each set of training items includes multiple images of the same subject. For an image generation system such as the one depicted in FIG. 5 that takes three images as input, each set of training items includes four images of the same subject. Three of the four images are used as inputs to the image generation system and may be referred to as reference images, while the fourth image is used as a target image for training purposes. It will be appreciated that the exact number of images in a set of training items will depend on the desired configuration.

The images in a particular set of training items thus all represent features of an “identity.” The images are preferably different images of the face of the subject. In some examples, the training data includes a relatively large number of sets of training items and covers a range of different identities (e.g., more than 2,500 or more than 5,000 different identities). In some examples, the different identities provide a diverse range of one or more of ages, genders, ethnicities, skin tones, hair colors, eye colors, or the like. In some examples, each set of training items also includes a text prompt, or caption, matching the target image in the set of training items.

At operation 1106, pre-trained components for an image generation system (e.g., the image generation system 230 of FIG. 2) are provided. In some examples, the pre-trained components include a pre-trained text encoder, as well as a pre-trained diffusion model that has been trained for text-to-image generation. The pre-trained diffusion model has thus been trained to take text prompt representations from the text encoder and to generate new images based on those text prompts. The pre-trained components may also include a pre-trained image encoder that can be connected to the pre-trained diffusion model, as described below.

At operation 1108, components in the form of new (trainable) components are provided for the image generation system. The new components include, in some examples, a merging component (e.g., the merge block 506 of FIG. 5) and new cross-attention layers for the pre-trained diffusion model (e.g., as diagrammatically depicted by arrows in FIG. 6). The merging component is linked to the diffusion model to feed combined identity representations to the diffusion model via the new cross-attention layers. The combined identity representations are transformed or merged versions of respective sets of identity representations generated by the image encoder from input images. Furthermore, in some examples, one or more other trainable components, such as the projection network 504 shown in FIG. 5, are integrated between the merging component and the image encoder to transform or modify image encoder outputs before they reach the merging component.

Accordingly, in some examples, a pre-trained generative model is adapted by providing new parameters that form part of new layers of the model (e.g., for the image feature cross-attention 522 of FIG. 5), and further new parameters that form part of a trainable merging component (e.g., the merge block 506).

Parameters of the pre-trained components are frozen at operation 1110 to preserve the integrity and capabilities of the pre-trained components, and to reduce overall training requirements (and thus processing resource requirements) and speed up the training process. At operation 1112, the method 1100 includes performing training (e.g., using the artificial intelligence and machine learning system 232 of FIG. 2) to adjust parameters of the new components described above, while the pre-trained components are kept frozen. Accordingly, where the image generation system includes a pre-trained diffusion model, a pre-trained text encoder (e.g., the text encoder 512), and a pre-trained image encoder (e.g., the image encoder 502), parameters of these components are kept unchanged during the training process of the method 1100. In this way, a multimodal image generation system can be relatively quickly obtained by using the pre-trained components as a base.

In some examples, the image encoder is pre-trained to encode each input image into a set of latent tokens (e.g., a latent-space representation). The merging component can then be trained to merge multiple sets of these tokens into a single set of tokens to define a combined identity representation. The combined identity representation captures facial features of the subject depicted in the input images (e.g., the three reference images referred to above).

The new parameters of the diffusion model are utilized to process combined identity representations. The diffusion model predicts a single output image from both the multiple input images, as represented by the combined identity representation, and a text prompt, as represented by a text prompt representation.

In some examples, during the training process of operation 1112, an objective function quantifies how well the generated output image matches the target image. The image generation system uses the merging component and diffusion model and tries to “reconstruct” the target image. For example, in a set of training items with four images, it aims to reconstruct the fourth (target) image from three input (reference) images and a text prompt.

One or more loss functions are employed to measure discrepancies between the features of the generated image and those of the target image, thereby encouraging the model to minimize these discrepancies. As a result, parameters of the merging component and parameters of the new layers of the diffusion model are adjusted as training progresses. By repeatedly training on various sets of images and corresponding targets, the image generation system learns to abstract essential, characterizing, and/or non-temporary identity characteristics that are consistent across different images of the same person, and thereby obtain a personalized output image depicting an AI-generated person with facial features that closely match those of the subject in the target image.

It is noted that the image generation system is trained in a many-to-one fashion. In other words, multiple input images are used, while only a single output image is generated. In some examples, this training objective is useful in enhancing the fidelity and consistency of generated images. By training the model to consolidate multiple features, views, and/or expressions into a unified or combined identity representation, the system can produce output images that maintain core identity attributes of a subject across various scenarios and conditions.

Moreover, the many-to-one training approach can improve the ability of the image generation system to generalize from limited data while reducing the risk of overfitting to specific images. This is achieved, for example, by teaching the image generation system to focus on stable, identity-defining features rather than transient or image-specific details.

After training is completed, the method 1100 proceeds to operation 1114, where the image generation system is deployed. For example, the image generation system can be deployed as the image generation system 230 of FIG. 2 to generate a personalized output image based on input images depicting a new, unseen subject. It is noted that the method 1100 may involve testing and evaluation operations that are performed prior to deployment, such as the model evaluation 908 and/or the validation, refinement or retraining 912 operations of FIG. 9. The operation method 1100 concludes at closing loop operation 1116.

As explained with reference to FIG. 5 and FIG. 6, in some examples, the text cross-attention and image cross-attention of the image generation system (e.g., the diffusion model 508 or the diffusion model 602) are detached. As a result, it is possible to adjust the weight of the image condition (e.g., the combined identity representation) relative to the text condition (e.g., the text prompt representation) for inference purposes. For example, if the weight of the image condition is changed to zero, the overall model simply reverts to functioning like the original, pre-trained diffusion model for text-to-image operations. Conversely, if the weight of the text condition is changed to zero, the overall model generates an output image based solely on image features (e.g., a combined identity representation).

As mentioned, other image generation controls, such as structural conditions, can also be integrated into a generative machine learning model of the present disclosure. Where a pre-trained model is used as a base, other image generation controls can be added via further components. Such other image generation controls can be utilized in addition to, or as alternatives to, text prompts.

In some examples, instead of using pre-trained model components, all trainable components of an image generation system can be trained “from scratch.” For example, and referring to FIG. 5, the image encoder 502, the projection network 504, the merge block 506, the diffusion model 508, and the text encoder 512 can be trained during such a training process.

### Data Communications Architecture

FIG. 12 is a schematic diagram illustrating a structure of a message 1200, according to some examples, generated by an interaction client 104 for communication to a further interaction client 104 via the interaction servers 124. The content of a particular message 1200 may be used to populate the message table 304 stored within the database 128 of FIG. 1, accessible by the interaction servers 124. Similarly, the content of a message 1200 is stored in memory as “in-transit” or “in-flight” data of the user system 102 or the interaction servers 124. A message 1200 is shown to include the following example components:
Message identifier 1202: a unique identifier that identifies the message 1200.
Message text payload 1204: text, to be generated by a user via a user interface of the user system 102, and that is included in the message 1200.
Message image payload 1206: image data, captured by a camera component of a user system 102 or retrieved from a memory component of a user system 102, and that is included in the message 1200. Image data for a sent or received message 1200 may be stored in the image table 314. The message image payload 1206 can, in some examples, include an image generated automatically using generative AI techniques described in the present disclosure.
Message video payload 1208: video data, captured by a camera component or retrieved from a memory component of the user system 102, and that is included in the message 1200. Video data for a sent or received message 1200 may be stored in the video table 312. The message video payload 1208 can, in some examples, include a video file generated automatically using generative AI techniques described in the present disclosure.
Message audio payload 1210: audio data, captured by a microphone or retrieved from a memory component of the user system 102, and that is included in the message 1200.
Message augmentation data 1212: augmentation data (e.g., filters, stickers, or other annotations or enhancements) that represents augmentations to be applied to message image payload 1206, message video payload 1208, or message audio payload 1210 of the message 1200. Augmentation data for a sent or received message 1200 may be stored in the augmentation table 310.
Message duration parameter 1214: parameter value indicating, in seconds, the amount of time for which content of the message (e.g., the message image payload 1206, message video payload 1208, message audio payload 1210) is to be presented or made accessible to a user via the interaction client 104.
Message geolocation parameter 1216: geolocation data (e.g., latitudinal and longitudinal coordinates) associated with the content payload of the message. Multiple message geolocation parameter 1216 values may be included in the payload, each of these parameter values being associated with respect to content items included in the content (e.g., a specific image within the message image payload 1206, or a specific video in the message video payload 1208).
Message collection identifier 1218: identifier values identifying one or more content collections (e.g., “stories” identified in the collections table 316) with which a particular content item in the message image payload 1206 of the message 1200 is associated. For example, multiple images within the message image payload 1206 may each be associated with multiple content collections using identifier values.
Message tag 1220: each message 1200 may be tagged with multiple tags, each of which is indicative of the subject matter of content included in the message payload. For example, where a particular image included in the message image payload 1206 depicts an animal (e.g., a lion), a tag value may be included within the message tag 1220 that is indicative of the relevant animal. Tag values may be generated manually, based on user input, or may be automatically generated using, for example, image recognition.
Message sender identifier 1222: an identifier (e.g., a messaging system identifier, email address, or device identifier) indicative of a user of the user system 102 on which the message 1200 was generated and from which the message 1200 was sent.
Message receiver identifier 1224: an identifier (e.g., a messaging system identifier, email address, or device identifier) indicative of a user of the user system 102 to which the message 1200 is addressed.

The contents (e.g., values) of the various components of message 1200 may be pointers to locations in tables within which content data values are stored. For example, an image value in the message image payload 1206 may be a pointer to (or address of) a location within an image table 314. Similarly, values within the message video payload 1208 may point to data stored within a video table 312, values stored within the message augmentation data 1212 may point to data stored in an augmentation table 310, values stored within the message collection identifier 1218 may point to data stored in a collections table 316, and values stored within the message sender identifier 1222 and the message receiver identifier 1224 may point to user records stored within an entity table 306.

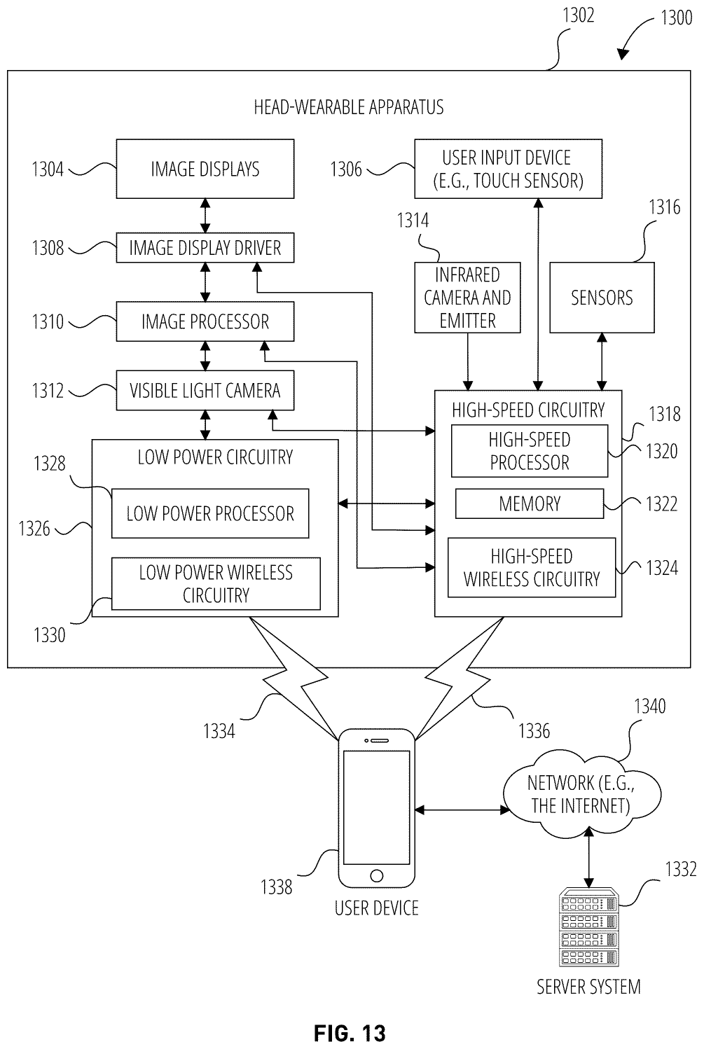

FIG. 13 illustrates a network environment 1300 in which a head-wearable apparatus 1302, e.g., a head-wearable XR device, can be implemented according to some examples. FIG. 13 provides a high-level functional block diagram of an example head-wearable apparatus 1302 communicatively coupled a mobile user device 1338 and a server system 1332 via a suitable network 1340. One or more of the techniques described herein may be performed using the head-wearable apparatus 1302 or a network of devices similar to those shown in FIG. 13.

The head-wearable apparatus 1302 includes a camera, such as at least one of a visible light camera 1312 and an infrared camera and emitter 1314. The head-wearable apparatus 1302 includes other sensors 1316, such as motion sensors or eye tracking sensors. The user device 1338 can be capable of connecting with head-wearable apparatus 1302 using both a communication link 1334 and a communication link 1336. The user device 1338 is connected to the server system 1332 via the network 1340. The network 1340 may include any combination of wired and wireless connections.

The head-wearable apparatus 1302 includes a display arrangement that has several components. The arrangement includes two image displays 1304 of an optical assembly. The two displays include one associated with the left lateral side and one associated with the right lateral side of the head-wearable apparatus 1302. The head-wearable apparatus 1302 also includes an image display driver 1308, an image processor 1310, low power circuitry 1326, and high-speed circuitry 1318. The image displays 1304 are for presenting images and videos, including an image that can provide a graphical user interface to a user of the head-wearable apparatus 1302.

The image display driver 1308 commands and controls the image display of each of the image displays 1304. The image display driver 1308 may deliver image data directly to each image display of the image displays 1304 for presentation or may have to convert the image data into a signal or data format suitable for delivery to each image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The head-wearable apparatus 1302 may include a frame and stems (or temples) extending from a lateral side of the frame, or another component to facilitate wearing of the head-wearable apparatus 1302 by a user. The head-wearable apparatus 1302 of FIG. 13 further includes a user input device 1306 (e.g., touch sensor or push button) including an input surface on the head-wearable apparatus 1302. The user input device 1306 is configured to receive, from the user, an input selection to manipulate the graphical user interface of the presented image.

The components shown in FIG. 13 for the head-wearable apparatus 1302 are located on one or more circuit boards, for example a printed circuit board (PCB) or flexible PCB, in the rims or temples. Alternatively, or additionally, the depicted components can be located in the chunks, frames, hinges, or bridges of the head-wearable apparatus 1302. Left and right sides of the head-wearable apparatus 1302 can each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1302 includes a memory 1322 which stores instructions to perform at least a subset of functions of the head-wearable apparatus 1302. The memory 1322 can also include a storage device. As further shown in FIG. 13, the high-speed circuitry 1318 includes a high-speed processor 1320, the memory 1322, and high-speed wireless circuitry 1324. In FIG. 13, the image display driver 1308 is coupled to the high-speed circuitry 1318 and operated by the high-speed processor 1320 in order to drive the left and right image displays of the image displays 1304. The high-speed processor 1320 may be any processor capable of managing high-speed communications and operation of any general computing system needed for the head-wearable apparatus 1302. The high-speed processor 1320 includes processing resources needed for managing high-speed data transfers over the communication link 1336 to a wireless local area network (WLAN) using high-speed wireless circuitry 1324. In certain examples, the high-speed processor 1320 executes an operating system such as a LINUX operating system or other such operating system of the head-wearable apparatus 1302 and the operating system is stored in memory 1322 for execution. In addition to any other responsibilities, the high-speed processor 1320 executing a software architecture for the head-wearable apparatus 1302 is used to manage data transfers with high-speed wireless circuitry 1324. In certain examples, high-speed wireless circuitry 1324 is configured to implement Institute of Electrical and Electronic Engineers (IEEE) 1302.11 communication standards, also referred to herein as Wi-Fi™. In other examples, other high-speed communications standards may be implemented by high-speed wireless circuitry 1324.

The low power wireless circuitry 1330 and the high-speed wireless circuitry 1324 of the head-wearable apparatus 1302 can include short range transceivers (e.g., Bluetooth™) and wireless wide, local, or wide area network transceivers (e.g., cellular or Wi-Fi™). The user device 1338, including the transceivers communicating via the communication link 1334 and communication link 1336, may be implemented using details of the architecture of the head-wearable apparatus 1302, as can other elements of the network 1340.

The memory 1322 includes any storage device capable of storing various data and applications, including, among other things, camera data generated by the visible light camera 1312, sensors 1316, and the image processor 1310, as well as images generated for display by the image display driver 1308 on the image displays 1304. While the memory 1322 is shown as integrated with the high-speed circuitry 1318, in other examples, the memory 1322 may be an independent standalone element of the head-wearable apparatus 1302. In certain such examples, electrical routing lines may provide a connection through a chip that includes the high-speed processor 1320 from the image processor 1310 or low power processor 1328 to the memory 1322. In other examples, the high-speed processor 1320 may manage addressing of memory 1322 such that the low power processor 1328 will boot the high-speed processor 1320 any time that a read or write operation involving memory 1322 is needed.

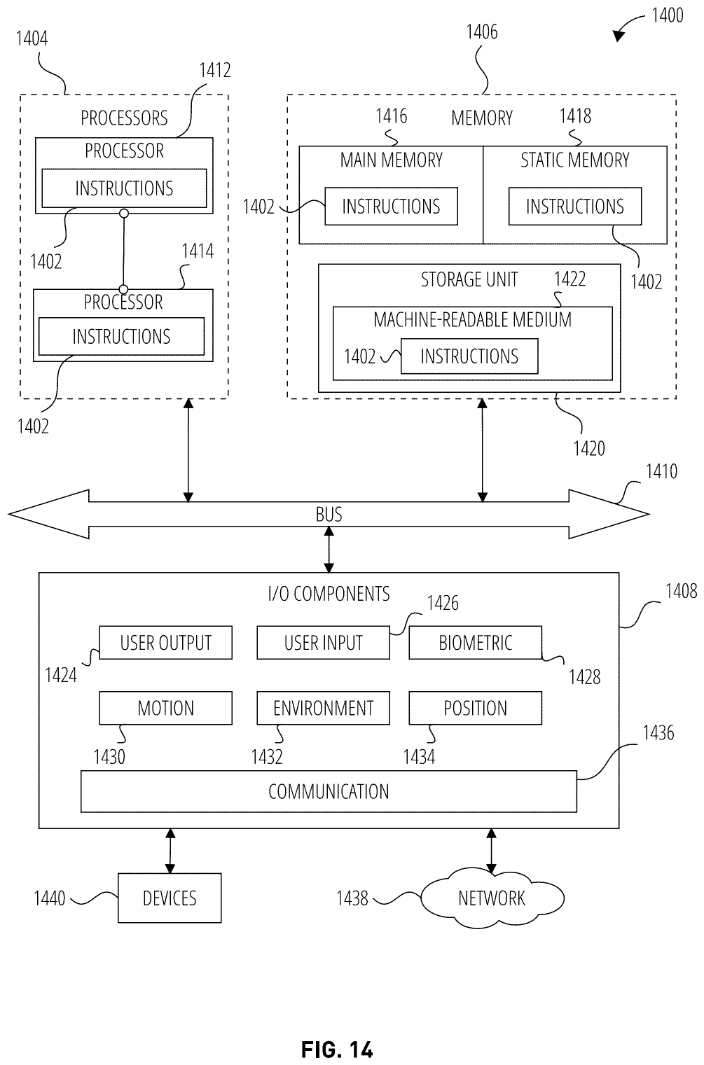

As shown in FIG. 13, the low power processor 1328 or high-speed processor 1320 of the head-wearable apparatus 1302 can be coupled to the camera (visible light camera 1312, or infrared camera and emitter 1314), the image display driver 1308, the user input device 1306 (e.g., touch sensor or push button), and the memory 1322. The head-wearable apparatus 1302 also includes sensors 1316, which may be the motion components 1430, position components 1434, environmental components 1432, and biometric components 1428, e.g., as described below with reference to FIG. 14. In particular, motion components 1430 and position components 1434 are used by the head-wearable apparatus 1302 to determine and keep track of the position and orientation (the “pose”) of the head-wearable apparatus 1302 relative to a frame of reference or another object, in conjunction with a video feed from one of the visible light cameras 1312, using for example techniques such as structure from motion (SfM) or Visual Inertial Odometry (VIO).

In some examples, and as shown in FIG. 13, the head-wearable apparatus 1302 is connected with a host computer. For example, the head-wearable apparatus 1302 is paired with the user device 1338 via the communication link 1336 or connected to the server system 1332 via the network 1340. The server system 1332 may be one or more computing devices as part of a service or network computing system, for example, that include a processor, a memory, and network communication interface to communicate over the network 1340 with the user device 1338 and head-wearable apparatus 1302.

The user device 1338 includes a processor and a network communication interface coupled to the processor. The network communication interface allows for communication over the network 1340, communication link 1334 or communication link 1336. The user device 1338 can further store at least portions of the instructions for implementing functionality described herein.

Output components of the head-wearable apparatus 1302 include visual components, such as a display (e.g., one or more liquid-crystal display (LCD)), one or more plasma display panel (PDP), one or more light emitting diode (LED) display, one or more projector, or one or more waveguide. The image displays 1304 of the optical assembly are driven by the image display driver 1308. The output components of the head-wearable apparatus 1302 further include acoustic components (e.g., speakers), haptic components (e.g., a vibratory motor), other signal generators, and so forth. The input components of the head-wearable apparatus 1302, the user device 1338, and server system 1332, such as the user input device 1306, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1302 may optionally include additional peripheral device elements. Such peripheral device elements may include biometric sensors, additional sensors, or display elements integrated with the head-wearable apparatus 1302. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 1336 from the user device 1338 via the low power wireless circuitry 1330 or high-speed wireless circuitry 1324.

Any biometric data collected by the biometric components is captured and stored with only user approval and deleted on user request, in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

### Machine Architecture

FIG. 14 is a diagrammatic representation of a machine 1400 within which instructions 1402 (e.g., software, a program, an application, an applet, an app, or other executable code) for causing the machine 1400 to perform any one or more of the methodologies discussed herein may be executed. For example, the instructions 1402 may cause the machine 1400 to execute any one or more of the methods described herein. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. The machine 1400, for example, may comprise the user system 102 or any one of multiple server devices forming part of the interaction server system 110. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1408, which may be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1412 and a processor 1414 that execute the instructions 1402. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, both accessible to the processors 1404 via the bus 1410. The main memory 1406, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 may include biometric components 1428, motion components 1430, environmental components 1432, or position components 1434, among a wide array of other components. For example, the biometric components 1428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1430 include acceleration sensor components (e.g., accelerometer), gravitation sensor components, rotation sensor components (e.g., gyroscope).

The environmental components 1432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple camera systems may include a wide camera, an ultra-wide camera, a telephoto camera, a macro camera, and a depth sensor, for example.

The position components 1434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1436 operable to couple the machine 1400 to a network 1438 or devices 1440 via respective coupling or connections. For example, the communication components 1436 may include a network interface component or another suitable device to interface with the network 1438. In further examples, the communication components 1436 may include wired communication components, wireless communication components, cellular communication components, Near Field Communication (NFC) components, Bluetooth™ components (e.g., Bluetooth™ Low Energy), Wi-Fi components, and other communication components to provide communication via other modalities. The devices 1440 may be another machine or any of a wide variety of peripheral devices (e.g., a peripheral device coupled via a USB).

Moreover, the communication components 1436 may detect identifiers or include components operable to detect identifiers. For example, the communication components 1436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1436, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1438, using a transmission medium, via a network interface device (e.g., a network interface component included in the communication components 1436) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1440.

### Software Architecture

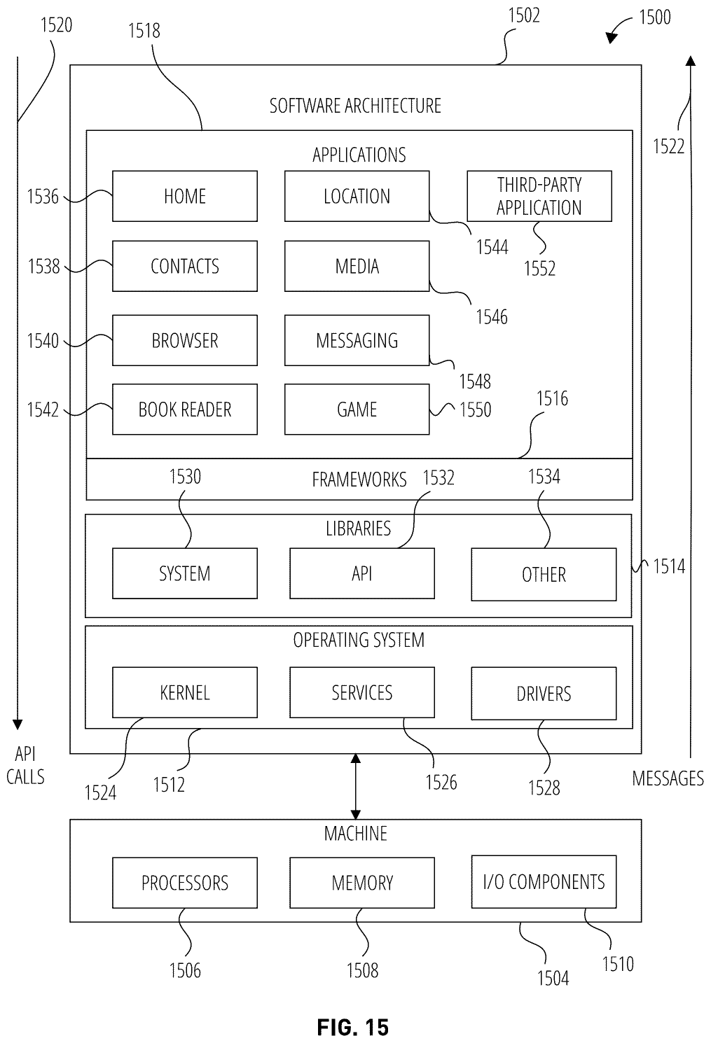

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, Bluetooth™ or Bluetooth™ Low Energy drivers, flash memory drivers, serial communication drivers (e.g., USB drivers), WI-FI drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematical functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a contacts application 1538, a browser application 1540, a book reader application 1542, a location application 1544, a media application 1546, a messaging application 1548, a game application 1550, and a broad assortment of other applications such as a third-party application 1552. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1552 (e.g., an application developed using the ANDROID™ or IOS™ SDK by an entity other than the vendor of the particular platform) may be mobile software running on a mobile operating system such as IOS™, ANDROID™, WINDOWS® Phone, or another mobile operating system. In this example, the third-party application 1552 can invoke the API calls 1520 provided by the operating system 1512 to facilitate functionalities described herein.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; at least one memory component storing instructions that, when executed by the at least one processor, cause the at least one processor to perform operations comprising: accessing a plurality of input images provided by a user of an interaction application, each of the plurality of input images depicting at least part of a subject; encoding each input image of the plurality of input images to obtain, from the input image, an identity representation; combining the identity representations to obtain a combined identity representation associated with the subject; generating a personalized output image via a generative machine learning model that processes the combined identity representation and at least one additional image generation control; and causing presentation, at a user device, of the personalized output image in a user interface of the interaction application.

In Example 2, the subject matter of Example 1 includes, wherein the at least one additional image generation control comprises a text prompt representation that is obtained from a text prompt.

In Example 3, the subject matter of Example 2 includes, wherein the operations further comprise: receiving, via the user device, user input comprising the text prompt, wherein the personalized output image is generated in response to receiving the text prompt.

In Example 4, the subject matter of any of Examples 1-3 includes, wherein each of the plurality of input images depicts a face of the subject and differs from the other input images in the plurality of input images, and the combined identity representation comprises a representation of facial features of the subject.

In Example 5, the subject matter of Example 4 includes, wherein the operations further comprise: causing presentation, at the user device, of an instruction to provide, among the plurality of input images, at least one of depictions of the face of the subject from different angles or depictions of different facial expressions of the subject.

In Example 6, the subject matter of Examples 1-5 includes, wherein the operations further comprise: causing launching of a real-time camera feed of the interaction application at the user device; and enabling the user to capture one or more of the plurality of input images via the real-time camera feed of the interaction application.

In Example 7, the subject matter of any of Examples 1-6 includes, wherein generating of the personalized output image comprises providing the combined identity representation and the at least one additional image generation control to the generative machine learning model via a decoupled cross-attention mechanism that separately processes the combined identity representation and the at least one additional image generation control.

In Example 8, the subject matter of Example 7 includes, wherein the generative machine learning model comprises separate cross-attention layers for the combined identity representation and the at least one additional image generation control, respectively.

In Example 9, the subject matter of any of Examples 1-8 includes, wherein the generative machine learning model comprises a diffusion model.

In Example 10, the subject matter of any of Examples 1-9 includes, wherein the at least one additional image generation control comprises one or more structural conditions to guide generation of the personalized output image.

In Example 11, the subject matter of Example 10 includes, wherein the at least one additional image generation control further comprises a text prompt representation that is obtained from a text prompt.

In Example 12, the subject matter of any of Examples 1-11 includes, wherein combining of the identity representations comprises processing the identity representations via a machine learning-based merging component to merge the identity representations into the combined identity representation, the merging component being trained to generate, for a given set of identity representations encoded from respective training images of a person, a corresponding combined identity representation for the person.

In Example 13, the subject matter of any of Examples 1-12 includes, wherein the operations further comprise: providing a pre-trained version of the generative machine learning model comprising predetermined parameters for processing the at least one additional image generation control; defining new parameters to process combined identity representations; and performing training to adjust the new parameters while keeping the predetermined parameters frozen.

In Example 14, the subject matter of Example 13 includes, wherein combining of the identity representations comprises processing the identity representations to merge the identity representations into the combined identity representation, and the operations further comprise: defining further new parameters to generate, for a given set of identity representations encoded from respective images of a person, a corresponding combined identity representation for the person, wherein the training is performed to adjust the new parameters and the further new parameters.

In Example 15, the subject matter of Example 14 includes, wherein the new parameters form part of new layers of the generative machine learning model, and the further new parameters form part of a machine-learning-based merging component that is trained to merge the identity representations into the combined identity representation.

In Example 16, the subject matter of any of Examples 13-15 includes, wherein each of the plurality of input images is encoded by an image encoder, and parameters of the image encoder are kept frozen while performing the training with respect to the new parameters.

In Example 17, the subject matter of any of Examples 13-16 includes, wherein the at least one additional image generation control comprises a text prompt representation that is obtained from a text prompt via a text encoder, and parameters of the text encoder are kept frozen while performing the training with respect to the new parameters.

In Example 18, the subject matter of any of Examples 1-17 includes, wherein the personalized output image is one of a plurality of frames of a personalized video, and the personalized video is generated for the user, via the interaction application, based on the combined identity representation and the at least one additional image generation control.

Example 19 is a method comprising: accessing, by one or more processors, a plurality of input images provided by a user of an interaction application, each of the plurality of input images depicting at least part of a subject; encoding, by the one or more processors, each input image of the plurality of input images to obtain, from the input image, an identity representation; combining, by the one or more processors, the identity representations to obtain a combined identity representation associated with the subject; generating, by the one or more processors, a personalized output image via a generative machine learning model that processes the combined identity representation and an additional image generation control; and causing, by the one or more processors, presentation of the personalized output image in a user interface of the interaction application at a user device.

Example 20 is a non-transitory computer-readable storage medium storing instructions that, when executed by at least one processor, cause the at least one processor to perform operations comprising: accessing a plurality of input images provided by a user of an interaction application, each of the plurality of input images depicting at least part of a subject; encoding each input image of the plurality of input images to obtain, from the input image, an identity representation; combining the identity representations to obtain a combined identity representation associated with the subject; generating a personalized output image via a generative machine learning model that processes the combined identity representation and an additional image generation control; and causing presentation, at a user device, of the personalized output image in a user interface of the interaction application.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Conclusion

As used in this disclosure, the term “machine learning model” (or simply “model”) may refer to a single, standalone model, or a combination of models. The term may also refer to a system, component, or module that includes a machine learning model together with one or more supporting or supplementary components that do not necessarily perform machine learning tasks.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device,” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User device” refers, for example, to a device accessed, controlled, or owned by a user and with which the user interacts to perform an action, or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing a plurality of input images provided by a user of an interaction application, each of the plurality of input images depicting at least part of a subject;
encoding each input image of the plurality of input images to obtain, from the input image, an identity representation;
combining the identity representations to obtain a combined identity representation associated with the subject;
generating a personalized output image via a generative machine learning model that processes the combined identity representation and at least one additional image generation control; and
causing presentation, at a user device, of the personalized output image in a user interface of the interaction application.

2. The system of claim 1, wherein the at least one additional image generation control comprises a text prompt representation that is obtained from a text prompt.

3. The system of claim 2, wherein the operations further comprise:
receiving, via the user device, user input comprising the text prompt, wherein the personalized output image is generated in response to receiving the text prompt.

4. The system of claim 1, wherein each of the plurality of input images depicts a face of the subject and differs from the other input images in the plurality of input images, and the combined identity representation comprises a representation of facial features of the subject.

5. The system of claim 4, wherein the operations further comprise:
causing presentation, at the user device, of an instruction to provide, among the plurality of input images, at least one of depictions of the face of the subject from different angles or depictions of different facial expressions of the subject.

6. The system of claim 1, wherein the operations further comprise:
causing launching of a real-time camera feed of the interaction application at the user device; and
enabling the user to capture one or more of the plurality of input images via the real-time camera feed of the interaction application.

7. The system of claim 1, wherein generating of the personalized output image comprises providing the combined identity representation and the at least one additional image generation control to the generative machine learning model via a decoupled cross-attention mechanism that separately processes the combined identity representation and the at least one additional image generation control.

8. The system of claim 7, wherein the generative machine learning model comprises separate cross-attention layers for the combined identity representation and the at least one additional image generation control, respectively.

9. The system of claim 1, wherein the generative machine learning model comprises a diffusion model.

10. The system of claim 1, wherein the at least one additional image generation control comprises one or more structural conditions to guide generation of the personalized output image.

11. The system of claim 10, wherein the at least one additional image generation control further comprises a text prompt representation that is obtained from a text prompt.

12. The system of claim 1, wherein combining of the identity representations comprises processing the identity representations via a machine learning-based merging component to merge the identity representations into the combined identity representation, the merging component being trained to generate, for a given set of identity representations encoded from respective training images of a person, a corresponding combined identity representation for the person.

13. The system of claim 1, wherein the operations further comprise:
providing a pre-trained version of the generative machine learning model comprising predetermined parameters for processing the at least one additional image generation control;
defining new parameters to process combined identity representations; and
performing training to adjust the new parameters while keeping the predetermined parameters frozen.

14. The system of claim 13, wherein combining of the identity representations comprises processing the identity representations to merge the identity representations into the combined identity representation, and the operations further comprise:
defining further new parameters to generate, for a given set of identity representations encoded from respective images of a person, a corresponding combined identity representation for the person, wherein the training is performed to adjust the new parameters and the further new parameters.

15. The system of claim 14, wherein the new parameters form part of new layers of the generative machine learning model, and the further new parameters form part of a machine-learning-based merging component that is trained to merge the identity representations into the combined identity representation.

16. The system of claim 13, wherein each of the plurality of input images is encoded by an image encoder, and parameters of the image encoder are kept frozen while performing the training with respect to the new parameters.

17. The system of claim 13, wherein the at least one additional image generation control comprises a text prompt representation that is obtained from a text prompt via a text encoder, and parameters of the text encoder are kept frozen while performing the training with respect to the new parameters.

18. The system of claim 1, wherein the personalized output image is one of a plurality of frames of a personalized video, and the personalized video is generated for the user, via the interaction application, based on the combined identity representation and the at least one additional image generation control.

19. A method comprising:
accessing, by one or more processors, a plurality of input images provided by a user of an interaction application, each of the plurality of input images depicting at least part of a subject;
encoding, by the one or more processors, each input image of the plurality of input images to obtain, from the input image, an identity representation;
combining, by the one or more processors, the identity representations to obtain a combined identity representation associated with the subject;
generating, by the one or more processors, a personalized output image via a generative machine learning model that processes the combined identity representation and an additional image generation control; and
causing, by the one or more processors, presentation of the personalized output image in a user interface of the interaction application at a user device.

20. A non-transitory computer-readable storage medium storing instructions that, when executed by at least one processor, cause the at least one processor to perform operations comprising:
accessing a plurality of input images provided by a user of an interaction application, each of the plurality of input images depicting at least part of a subject;
encoding each input image of the plurality of input images to obtain, from the input image, an identity representation;
combining the identity representations to obtain a combined identity representation associated with the subject;
generating a personalized output image via a generative machine learning model that processes the combined identity representation and an additional image generation control; and
causing presentation, at a user device, of the personalized output image in a user interface of the interaction application.
